(19) United States
(12) Patent Application Publication
(10) Pub. No.: US 2025/0053024 A1
(43) Pub. Date: Feb. 13, 2025

(54) LENS DRIVE DEVICE AND CAMERA MODULE

(71) Applicant: ALPS ALPINE CO., LTD., Tokyo (JP)

(72) Inventors: Hiroshi OSADA, Tokyo (JP); Masanobu MAEDA, Niigata (JP)

(21) Appl. No.: 18/791,674

(22) Filed: Aug. 1, 2024

(30) Foreign Application Priority Data
Aug. 10, 2023 (JP) 2023-130797

(51) Int. Cl. G02B 27/64; F03G 7/06; G03B 5/00; G03B 13/36

(52) U.S. Cl. CPC G02B 27/646; F03G 7/06143; G03B 5/00; G03B 13/36; G03B 2205/0007; G03B 2205/0076

(57) ABSTRACT

A lens drive device includes a support, a lens holder that includes a cylinder configured to arrange a lens body in the cylinder, and that is movable with respect to the support in a direction of an optical axis, and a plurality of shape memory alloy wires that are provided between the support and the lens holder, and that are configured to move the lens holder in the direction of the optical axis.

### CROSS-REFERENCE TO RELATED APPLICATIONS

The present application is based on and claims priority to Japanese Patent Application No. 2023-130797 filed on Aug. 10, 2023, the entire contents of which are hereby incorporated by reference.

### BACKGROUND

### 1. Field of the Invention

The present disclosure relates to a lens drive device and a camera module.

### 2. Description of the Related Art

A lens drive device using a shape memory alloy wire is known in International Publication No. WO2019/034860. This device is configured such that a lens holder can be moved by causing an electric current to flow to the shape memory alloy wire to heat and contract the shape memory alloy wire.

### SUMMARY

The lens drive device according to one embodiment of the present disclosure includes a support, a lens holder including a cylinder in which a lens body can be arranged and is movable in a direction of an optical axis (an optical axis direction) with respect to the support, and a plurality of shape memory alloy wires provided between the support and the lens holder configured to move the lens holder in the optical axis direction. The support includes a guide configured to guide the movement of the lens holder in the optical axis direction and a first magnetic member. The lens holder includes a guided part configured to slide with the guide and guided by the guide, and a second magnetic member arranged at a position apart from the first magnetic member in a direction crossing the optical axis direction. At least one of the first magnetic member or the second magnetic member is formed of a magnet. By exerting a force of pushing each other in the direction crossing the optical axis direction by a magnetic force generated between the first magnetic member and the second magnetic member, the guide and the guided part are arranged in a way contacting with each other regardless of the position of the lens holder in the optical axis direction.

### BRIEF DESCRIPTION OF DRAWINGS

FIG. 1 is a perspective view illustrating a camera module according to one embodiment of the present disclosure;

FIG. 2 is an exploded perspective view illustrating a lens drive device according to one embodiment of the present disclosure;

FIG. 3 is an exploded perspective view illustrating a body of the lens drive device according to one embodiment of the present disclosure;

FIG. 4 is a perspective view illustrating a fixed support;

FIG. 5 is a top view illustrating the fixed support;

FIG. 6 is a bottom view illustrating the fixed support;

FIG. 7 is a perspective view illustrating a lens holder;

FIG. 8 is a top view illustrating the lens holder;

FIG. 9 is a bottom view illustrating the lens holder;

FIG. 10 is a perspective view illustrating a support;

FIG. 11 is a top view illustrating the support;

FIG. 12 is a bottom view illustrating the support;

FIG. 13 is a view illustrating how a movable-side metal member, a fixed-side metal member, and an upper shape memory alloy wire are arranged;

FIG. 14 is a view illustrating how a lens-side metal member, a support-side metal member, and a lower shape memory alloy wire are arranged;

FIG. 15 is a top view illustrating the movable-side metal member, the fixed-side metal member, the upper shape memory alloy wire, and the lens holder;

FIG. 16 is a perspective view illustrating the movable-side metal member, the fixed-side metal member, a flexible metal member, an upper conductive member, and the upper shape memory alloy wire;

FIG. 17 is a perspective view illustrating a support-side metal member, a lens-side metal member, an upper conductive member, a lower conductive member, and a lower shape memory alloy wire;

FIG. 18 is a view illustrating an example of a path of current flowing through a first lower wire;

FIG. 19 is a view illustrating an example of a path of current flowing through a second lower wire;

FIG. 20 is a view illustrating an example of a path of current flowing through a third lower wire;

FIG. 21 is a view illustrating an example of a path of current flowing through a fourth lower wire;

FIG. 22 is a view illustrating how a lens holder, a support-side metal member, a lens-side metal member, a guide member, a first magnetic member, a second magnetic member, a yoke, and a lower shape memory alloy wire are arranged;

FIG. 23 is a front view illustrating the lens holder, the support, the support-side metal member, the lens-side metal member, the guide member, the first magnetic member, the second magnetic member, and the lower shape memory alloy wire;

FIG. 24 is a bottom view illustrating a support with a magnet attached; and

FIG. 25 is a perspective cross-sectional view illustrating a lower cover and the support.

### DETAILED DESCRIPTION OF THE PRESENT DISCLOSURE

In the device disclosed in International Publication No. WO2019/034860, the lens holder may move when no current is flowing through the shape memory alloy wire. Thus, it is necessary to keep the current flowing through the shape memory alloy wire in order to maintain the lens in focus, for example, when photographing a moving image. Therefore, saving power (reducing power consumed) may be challenging in this device.

Therefore, it is desirable to provide a lens drive device capable of achieving power saving.

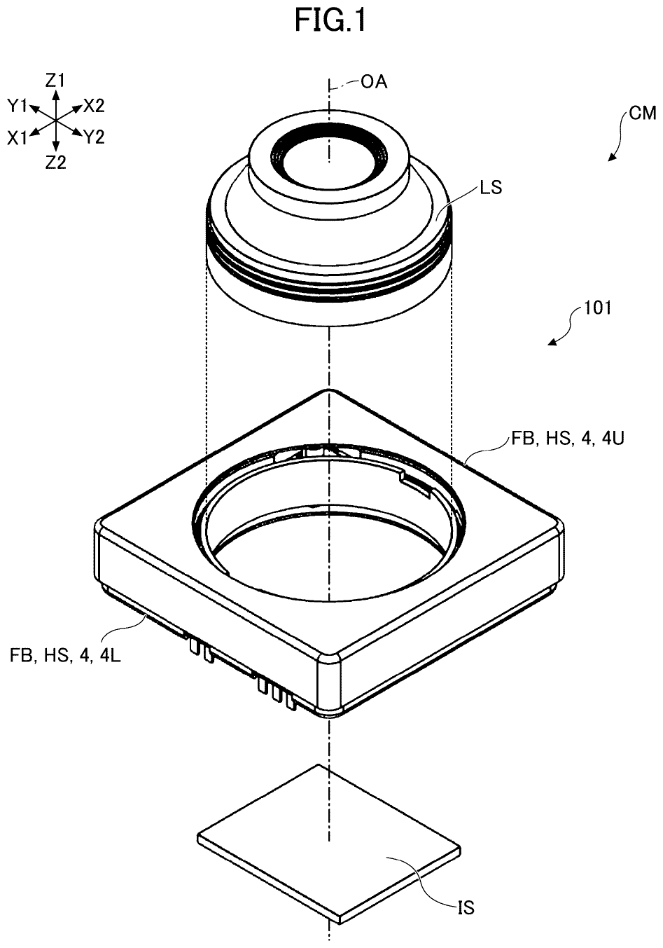

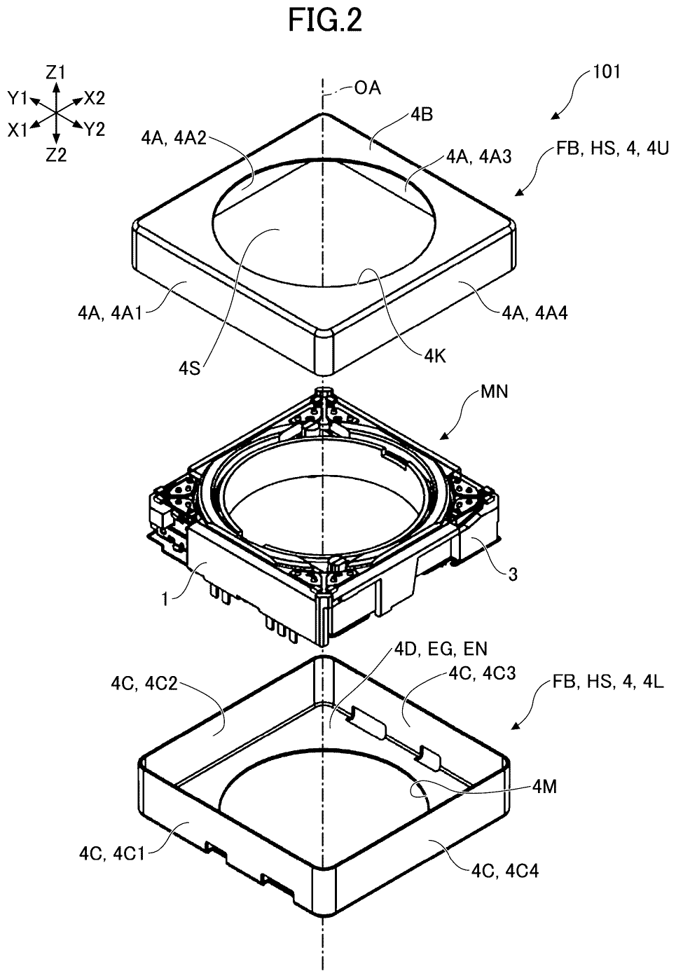

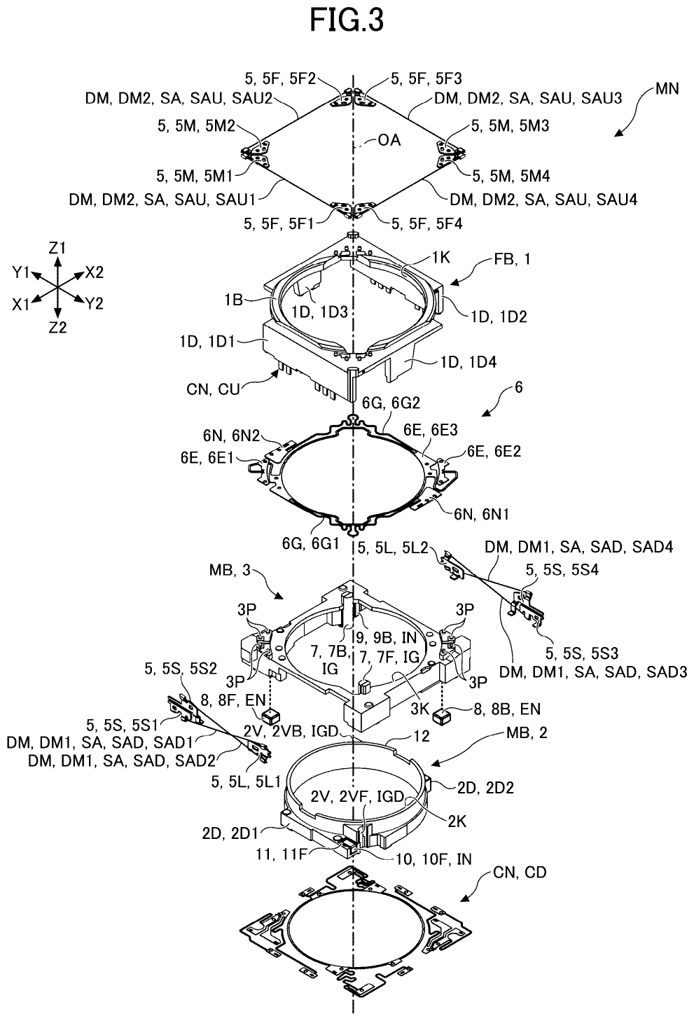

Hereinafter, a lens drive device 101 and a camera module CM according to an embodiment of the present disclosure will be described with reference to the drawings. FIG. 1 is a perspective view illustrating the camera module CM. FIG. 2 is an exploded perspective view illustrating the lens drive device 101 included in the camera module CM. FIG. 3 is an exploded perspective view illustrating a body MN included in the lens drive device 101.

In FIG. 1, X1 represents one direction of an X-axis of a three-dimensional orthogonal coordinate system, and X2 represents the other direction of the X-axis. Y1 represents one direction of a Y-axis of the three-dimensional orthogonal coordinate system, and Y2 represents the other direction of the Y-axis. Similarly, Z1 represents one direction of a Z-axis of the three-dimensional orthogonal coordinate system, and Z2 represents the other direction of the Z-axis. In FIG. 1, the X1 side of the lens drive device 101 corresponds to the front side of the lens drive device 101, and the X2 side of the lens drive device 101 corresponds to the rear side of the lens drive device 101. The Y1 side of the lens drive device 101 corresponds to the left side of the lens drive device 101, and the Y2 side of the lens drive device 101 corresponds to the right side of the lens drive device 101. The Z1 side of the lens drive device 101 corresponds to an upper side (a subject side) of the lens drive device 101, and the Z2 side of the lens drive device 101 corresponds to a lower side (an imaging element side) of the lens drive device 101. The same applies in other drawings.

As illustrated in FIG. 1, the camera module CM includes the lens drive device 101, a lens body LS mounted on a lens holder 2, and an imaging element IS mounted to an external substrate (not illustrated) so as to face the lens body LS. The lens body LS is a cylindrical lens barrel including at least one lens and includes an optical axis OA. In an illustrated example, the lens drive device 101 that has a nearly rectangular parallelepiped shape is mounted on an external substrate on which the imaging element IS is mounted. The imaging element IS may be mounted on the lower surface of the lens drive device 101 via a sensor holder (not illustrated).

Specifically, the lens drive device 101 includes a cover 4 of a fixed-side member FB, as illustrated in FIGS. 1 and 2. The cover 4 includes an upper cover 4U and a lower cover 4L. As illustrated in FIG. 2, the cover 4 has a box-like outer shape for defining a storage portion 4S. The cover 4 is configured to function as a housing HS for covering the above members. In the present embodiment, the cover 4 is formed of a magnetic metal. Therefore, the cover 4 also functions as an electromagnetic shield. In particular, the lower cover 4L is configured to function as an electromagnetic shield to suppress an electric field generated by the lens drive device 101 from becoming image noise to the imaging element IS. In the illustrated example, the lower cover 4L is formed of a magnetic metal so as to form an outer energizer EN described in the following, while the upper cover 4U may be formed of a non-magnetic metal.

In the illustrated example, the upper cover 4U includes a first outer-peripheral wall portion 4A that has a rectangular tubular shape and a top plate portion 4B that is a flat plate having a rectangular annular shape disposed so as to be continuous with an upper end (Z1 side end) of the first outer-peripheral wall portion 4A. A circular opening 4K is formed in the center of the top plate portion 4B. The first outer-peripheral wall portion 4A includes a first side-plate portion 4A1 to a fourth side-plate portion 4A4. The first side-plate portion 4A1 and the third side-plate portion 4A3 of the first outer-peripheral wall portion 4A are arranged so as to face each other, and the second side-plate portion 4A2 and the fourth side-plate portion 4A4 are arranged so as to face each other. The first side-plate portion 4A1 and the third side-plate portion 4A3 both extend perpendicularly to the second side-plate portion 4A2 and the fourth side-plate portion 4A4.

Similarly, as illustrated in FIG. 2, the lower cover 4L includes a second outer-peripheral wall portion 4C having a rectangular tubular shape and a bottom plate 4D that is a flat plate having a rectangular annular shape arranged so as to be continuous with a lower end (Z2 side end) of the second outer-peripheral wall portion 4C. A circular opening 4M is formed in the center of the bottom plate 4D. The second outer-peripheral wall portion 4C includes a first side-plate portion 4C1 to a fourth side-plate portion 4C4. The first side-plate portion 4C1 and the third side-plate portion 4C3 of the second outer-peripheral wall portion 4C are arranged so as to face each other, and the second side-plate portion 4C2 and the fourth side-plate portion 4C4 of the second outer-peripheral wall portion 4C are arranged so as to face each other. The first side-plate portion 4C1 and the third side-plate portion 4C3 both extend perpendicularly to the second side-plate portion 4C2 and the fourth side-plate portion 4C4.

As illustrated in FIG. 1, the upper cover 4U is bonded to the lower cover 4L by an adhesive. Specifically, the first outer-peripheral wall portion 4A is arranged to cover a part of the second outer-peripheral wall portion 4C. As illustrated in FIG. 2, the body MN is housed in the cover 4 functioning as the housing HS.

As illustrated in FIG. 3, the body MN includes a fixed support 1, the lens holder 2, a support 3, a metal member 5, a flexible metal member 6, a guide member 7, a magnet 8, a first magnetic member 9, a second magnetic member 10, a yoke 11, a conductive member CN, and a shape memory alloy wire SA. The lens holder 2 and the support 3 form a movable side member MB.

The fixed support 1 is formed by injection molding using a synthetic resin such as a liquid crystal polymer (LCP). In the present embodiment, as illustrated in FIG. 3, the fixed support 1 has a nearly rectangular outline in a plan view and includes an opening 1K in the center thereof. Specifically, the fixed support 1 includes a base 1B that has a nearly rectangular annular shape arranged so as to surround the opening 1K, which is circular, and a leg portion 1D formed to extend downward of an outer periphery of the base 1B. The leg portion 1D includes a first leg portion 1D1 to a fourth leg portion 1D4. In the illustrated example, the first leg portion 1D1 and the second leg portion 1D2 of the leg portion 1D are arranged so as to face each other in the X-axis direction across the optical axis OA. The third leg portion 1D3 and the fourth leg portion 1D4 of the leg portion 1D are arranged so as to face each other in the Y-axis direction across the optical axis OA.

The lens holder 2 is formed by injection molding the synthetic resin such as the liquid crystal polymer (LCP), and is configured to include an opening 2K penetrating vertically of the lens holder 2 so as to hold the lens body LS. Specifically, as illustrated in FIG. 3, the lens holder 2 includes a cylinder 12 formed to extend along the optical axis OA and a pedestal portion 2D formed to project radially outward of the cylinder 12. In the illustrated example, the lens body LS is configured to be fixed to an inner peripheral surface of the cylinder 12 with an adhesive. A spiral groove may be formed on the inner peripheral surface of the cylinder 12 so that the adhesive spreads between the inner peripheral surface of the cylinder 12 and the lens body LS.

The pedestal portion 2D includes a first pedestal portion 2D1 and a second pedestal portion 2D2. The first pedestal portion 201 and the second pedestal portion 2D2 are arranged so as to be positioned opposite to each other across the optical axis OA. A lens-side metal member 5L is attached to each of the two pedestal portions 2D.

The support 3 is formed by injection molding the synthetic resin such as the liquid crystal polymer (LCP). In the present embodiment, the support 3 has a nearly rectangular outline in a plan view and includes an opening 3K in the center thereof. Specifically, as illustrated in FIG. 3, the support 3 is a nearly rectangular annular member arranged so as to surround the circular opening 3K, which is circular.

The shape memory alloy wire SA is an example of a shape memory actuator and forms a driver DM for driving the movable side member MB. In the illustrated example, the shape memory alloy wire SA includes an upper shape memory alloy wire SAU and a lower shape memory alloy wire SAD. The upper shape memory alloy wire SAU includes a first upper wire SAU1 to a fourth upper wire SAU4, and the lower shape memory alloy wire SAD includes a first lower wire SAD1 to a fourth lower wire SAD4. When a current flows through the shape memory alloy wire SA, a temperature thereof increases and the shape memory alloy wire SA contracts in response to the increase in the temperature. The driver DM can move the movable side member MB by using the contraction of the shape memory alloy wire SA. In the illustrated example, the driver DM includes a first driver DM1 configured to cause the support 3 to move the lens holder 2 in the optical axis direction, and a second driver DM2 configured to cause the fixed-side member FB to move the support 3 in the direction perpendicular to the optical axis. The optical axis direction includes the direction of the optical axis OA of the lens body LS and the direction parallel to the optical axis OA. The first driver DM1 is formed of the lower shape memory alloy wire SAD, and the second driver DM2 is formed of the upper shape memory alloy wire SAU.

The flexible metal member 6 forms conductive connection member configured to connect the fixed support 1 and the support 3. In the present embodiment, the flexible metal member 6 is made of a metal plate mainly made of a copper alloy, a titanium-copper alloy (titanium-copper), a copper-nickel alloy (nickel-tin-copper), or the like. The flexible metal member 6 may be configured to function as an elastic support capable of elastically supporting the support 3 with respect to the fixed support 1.

In the illustrated example, the flexible metal member 6 includes a base fixing part 6N to be fixed to the fixed support 1, a support fixing part 6E to be fixed to the support 3, and a flexible arm part 6G configured to connect the base fixing part 6N and the support fixing part 6E. The base fixing part 6N includes a first base fixing part 6N1 and a second base fixing part 6N2, and the support fixing part 6E includes a first support fixing part 6E1, a second support fixing part 6E2, and a third support fixing part 6E3, which is nearly circular in a plan view. The flexible arm part 6G includes a first flexible arm part 6G1 configured to connect the first base fixing part 6N1 and the third support fixing part 6E3, and a second flexible arm part 6G2 configured to connect the second base fixing part 6N2 and the third support fixing part 6E3.

The metal member 5 is configured so that an end of the shape memory alloy wire SA can be fixed thereto. In the present embodiment, the metal member 5 is formed of a non-magnetic metal and includes a support-side metal member 5S as a first metal member, a lens-side metal member 5L as a second metal member, a fixed-side metal member 5F as a third metal member, and a movable-side metal member 5M as a fourth metal member. The support-side metal member 5S is configured to be fixed to the side surface of the support 3, the lens-side metal member 5L is configured to be fixed to the pedestal portion 2D of the lens holder 2, the fixed-side metal member 5F is configured to be fixed to an upper surface of the fixed support 1, and the movable-side metal member 5M is configured to be fixed to an upper surface of the support 3.

More specifically, the support-side metal member 5S is also referred to as a support-side terminal plate and includes a first support-side terminal plate 5S1 to a fourth support-side terminal plate 5S4. The lens-side metal member 5L is also referred to as a lens-side terminal plate and includes a first lens-side terminal plate 5L1 and a second lens-side terminal plate 5L2. The fixed-side metal member 5F is also referred to as a fixed-side terminal plate and includes a first fixed-side terminal plate 5F1 to a fourth fixed-side terminal plate 5F4. The movable-side metal member 5M is also referred to as a movable-side terminal plate and includes a first movable-side terminal plate 5M1 to a fourth movable-side terminal plate 5M4.

Each of the first lower wire SAD1 to the fourth lower wire SAD4 has one end fixed to the support-side metal member 5S such as by crimping or welding, and the other end fixed to the lens-side metal member 5L such as by crimping or welding. The first lower wire SAD1 to the fourth lower wire SAD4 are arranged so as to be stretched straight, when a current flows, along an inner surface of the second outer-peripheral wall portion 4C of the lower cover 4L, so that the support 3 can support the lens holder 2 so as to be movable in the optical axis direction.

One end in each of the first upper wire SAU1 to the fourth upper wire SAU4 is fixed to the fixed-side metal member 5F by crimping or welding, and the other end is fixed to the movable-side metal member 5M by crimping or welding. The first upper wire SAU1 to the fourth upper wire SAU4 are arranged so as to be stretched straight along a lower surface of the top plate portion 4B of the upper cover 4U when a current flows, so that the support 3 can be supported so as to be movable in a direction perpendicular to the optical axis OA relative to the fixed support 1.

The guide member 7 is an example of an inner guide IG, which is a guide for guiding the movement of the lens holder 2 in the optical axis direction, and is attached to the support 3. “Inner” in the inner guide IG means that the guide is disposed in the lens drive device 101 at an inner position relative to that of an outer guide EG (a position closer to the center of the lens drive device 101). However, the inner guide IG may be disposed at an outer position relative to that of the outer guide EG. In the illustrated example, the guide member 7 is formed of metal and includes a nearly cylindrical portion including a semi-cylindrical upper half portion and a cylindrical lower half portion. The guide member 7 also includes a rear guide member 7B that is to be attached to a left rear part of the support 3 and a front guide member 7F that is to be attached to a right front part of the support 3. The guide member 7 may include one or more nearly hemispherical portions instead of nearly cylindrical portions. The guide member 7 may be formed of a synthetic resin. In such a case, the guide member 7 may be integrated with the support 3 formed of the synthetic resin.

The lens holder 2 includes a groove 2V that receives the guide member 7. The groove 2V forms an inner guided part IGD guided by the guide member 7 as an inner guide IG. Specifically, the guide member 7 fixed to the support 3 forms the inner guide IG for guiding the lens holder 2 that is to be moved in the optical axis direction, and the groove 2V formed in the lens holder 2 for receiving the guide member 7 forms the inner guided part IGD guided by the inner guide IG. In the illustrated example, the groove 2V includes a rear groove 2VB formed in a left rear part of the lens holder 2 and a front groove 2VF formed in the right front part of the lens holder 2.

The magnet 8 is an example of a member included in the outer energizer EN as an energizer for exerting an attractive force between the fixed-side member FB and the support 3, and is attached to the support 3. The “outer” in the outer energizer EN means that the energizer is disposed in the lens drive device 101 on the outside (a position far from the center of the lens drive device 101) from an inner energizer IN described in the following. However, the outer energizer EN may be disposed inside the inner energizer IN. In the illustrated example, the magnet 8 is a nearly rectangular parallelepiped magnet which is bipolarly magnetized, and forms the outer energizer EN which, in cooperation with the bottom plate 4D of the lower cover 4L formed of magnetic metal, causes the fixed-side member FB and the support 3 to exert a force to attract each other. That is, the outer energizer EN uses a magnetic force (attractive force) acting between the magnet 8 fixed to the support 3 and the bottom plate 4D of the lower cover 4L as the fixed-side member FB to generate a force to attract each other between the fixed-side member FB and the support 3. In this case, the bottom plate 4D of the lower cover 4L forms the outer guide EG for guiding the support 3 to move in a direction perpendicular to the optical axis direction, and a part of the support 3 (a projecting portion 3S described in the following) forms an outer guided part EGD guided by the outer guide EG. The magnet 8 includes a rear magnet 8B attached to the right rear part of the support 3 and a front magnet 8F attached to the left front part of the support 3.

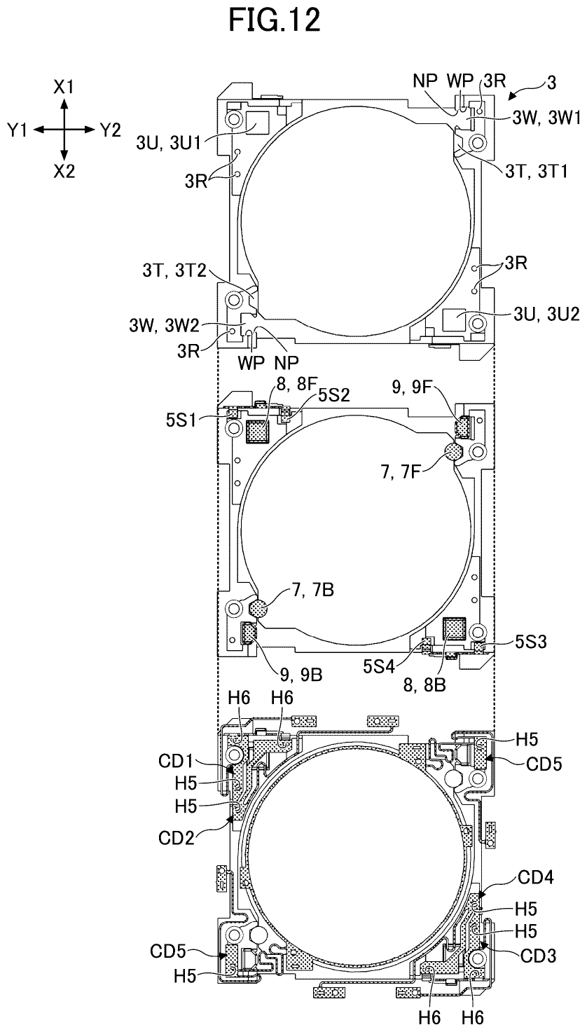

The first magnetic member 9 is an example of a member constituting the inner energizer IN, which is the energizer for exerting a force to push or pull the lens holder 2 and the support 3 against each other, and is attached to the support 3. In the illustrated example, the first magnetic member 9 is a bipolar-magnetized hexagonal columnar (nearly semi-octagonal columnar) magnet (see the central figure of FIG. 12), and forms the inner energizer IN, which exerts a force to pull the support 3 and the lens holder 2 against each other in cooperation with the second magnetic member 10. That is, the inner energizer IN uses a magnetic force (attractive force) acting between the first magnetic member 9 fixed to the support 3 and the second magnetic member 10 fixed to the lens holder 2, to generate a force to pull the support 3 and the lens holder 2 against each other. The first magnetic member 9 also includes a first rear magnetic member 9B attached to the left rear part of the support 3 and a first front magnetic member 9F attached to the right front part of the support 3 (see the central figure of FIG. 12).

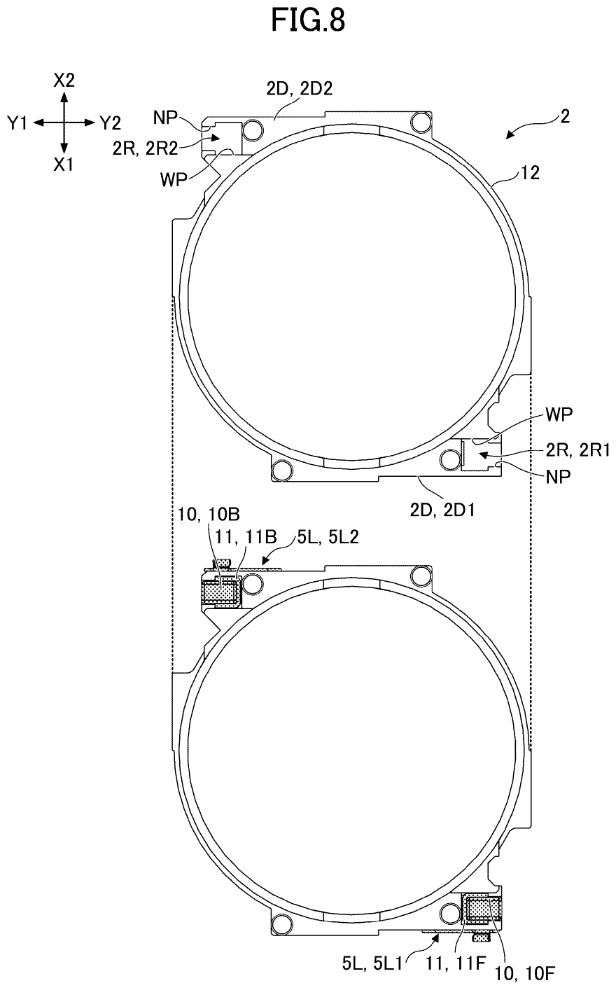

The second magnetic member 10 is another example of a member constituting the inner energizer IN and is attached to the lens holder 2. In the illustrated example, the second magnetic member 10 is a magnet that is bipolar magnetized and has a nearly rectangular parallelepiped shape, and cooperates with the first magnetic member 9 to form the inner energizer IN. The second magnetic member 10 is fixed to the lens holder 2 so as to face the first magnetic member 9 attached to the support 3 with a small gap between them. The second magnetic member 10 also includes a second rear magnetic member 10B attached to the left rear part of the lens holder 2 (see the lower figure in FIG. 8), and a second front magnetic member 10F attached to a right front part of the lens holder 2.

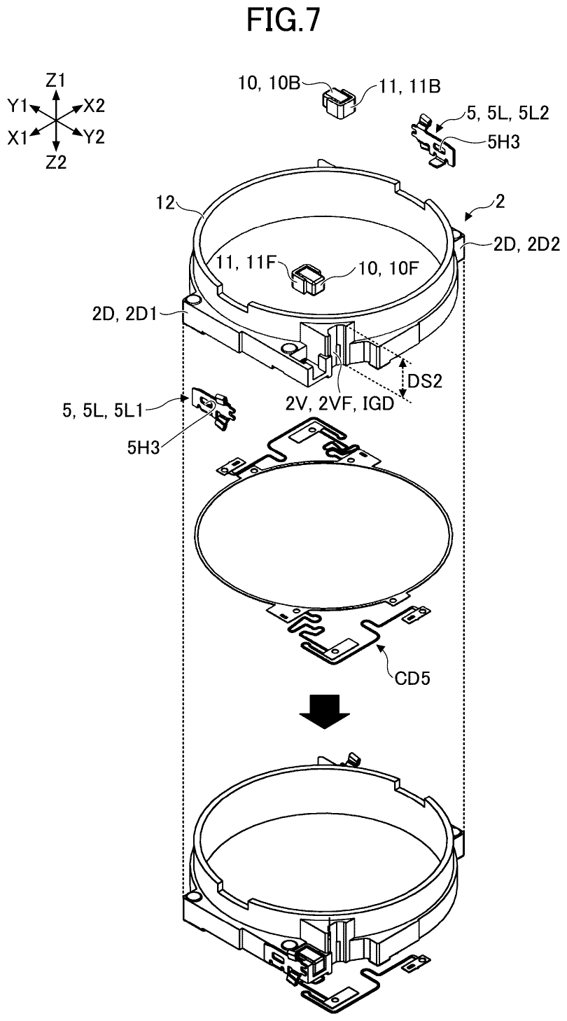

The yoke 11 controls a path of magnetic field lines generated by the second magnetic member 10 and is attached to the lens holder 2 together with the second magnetic member 10. In the illustrated example, as illustrated in FIG. 7, the yoke 11 is nearly U-shaped and covers a part of the second magnetic member 10 in a nearly rectangular parallelepiped shape. The yoke 11 also includes a rear yoke 11B attached to the left rear part of the lens holder 2 and a front yoke 11F attached to the right front part of the lens holder 2. The yoke 11 may be omitted.

In the illustrated example, the first magnetic member 9 and the second magnetic member 10 are both magnets, but at least one of them may be a magnet to form the inner energizer IN. This is because magnetic attraction can be generated between the first magnetic member 9 and the second magnetic member 10. In the illustrated example, the first magnetic member 9 and the second magnetic member 10 are arranged so as to generate magnetic attraction between the first magnetic member 9 and the second magnetic member 10, but may be arranged so as to generate magnetic repulsion (repulsion) between the first magnetic member 9 and the second magnetic member 10.

The conductive member CN is a member for conducting electricity and is formed of a magnetic metal such as iron or a non-magnetic metal such as a copper alloy. In the illustrated example, the conductive member CN includes an upper conductive member CU and a lower conductive member CD as illustrated in FIG. 3. The upper conductive member CU is a conductive member embedded in the fixed support 1. The lower conductive member CD is a conductive member attached to the lower surfaces of the fixed support 1, the lens holder 2, and the support 3.

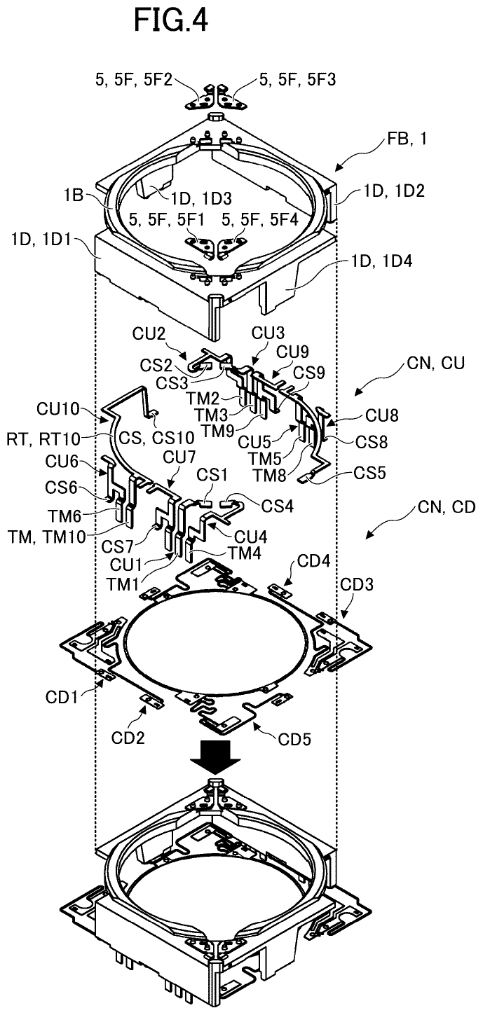

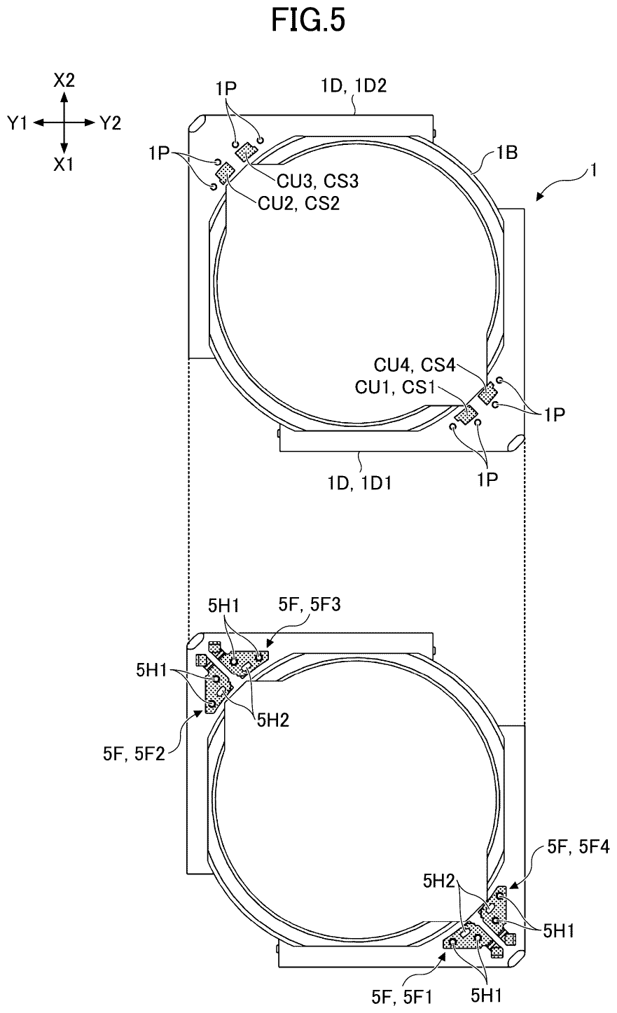

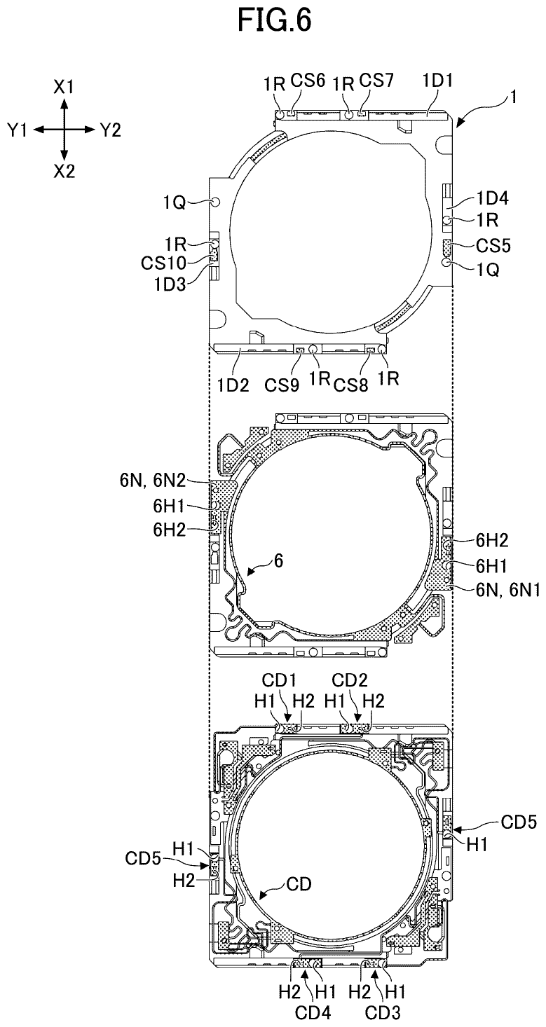

Next, with reference to FIGS. 4 to 6, details of the fixed support 1 as the fixed-side member FB will be described. FIG. 4 is a perspective view illustrating the fixed support 1 in which the upper conductive member CU is embedded and the fixed-side metal member 5F and the lower conductive member CD are attached. Specifically, the upper figures (above a block arrow) of FIG. 4 are perspective views illustrating the fixed-side metal member 5F, the fixed support 1, the upper conductive member CU, and the lower conductive member CD. The lower view (below the block arrow) of FIG. 4 is a perspective view illustrating the fixed support 1, in which the upper conductive member CU is embedded, and the fixed-side metal member 5F and the lower conductive member CD are attached thereto. Although the flexible metal member 6 is also attached to the fixed support 1, the flexible metal member 6 is not illustrated in FIG. 4 for clarity. FIG. 5 is a top view illustrating the fixed support 1 in which the upper conductive member CU is embedded. Specifically, the upper figure of FIG. 5 is a top view illustrating the fixed support 1 in a state in which the fixed-side metal member 5F is not attached, and the lower figure of FIG. 5 is a top view illustrating the fixed support 1 in a state in which the fixed-side metal member 5F is attached. FIG. 6 is a bottom view illustrating the fixed support 1 in which the upper conductive member CU is embedded. Specifically, the upper figure of FIG. 6 is a bottom view illustrating the fixed support 1 in a state in which the flexible metal member 6 and the lower conductive member CD are not attached. The central figure of FIG. 6 is a bottom view illustrating the fixed support 1 in a state in which the flexible metal member 6 is attached, and the lower figure of FIG. 6 is a bottom view illustrating the fixed support 1 in a state in which the lower conductive member CD is further attached. For clarity, in the upper figure of FIG. 5, a dotted pattern is applied to the upper conductive member CU, and in the lower figure of FIG. 5, a dotted pattern is applied to the fixed metal member 5F. In the upper figure of FIG. 6, a dotted pattern is applied to the upper conductive member CU, in the central figure of FIG. 6, a dotted pattern is applied to the flexible metal member 6, and in the lower figure of FIG. 6, a dotted pattern is applied to the lower conductive member CD.

As illustrated in FIG. 4, the upper conductive member CU is embedded in the fixed support 1 by insert molding. In the present embodiment, the upper conductive member CU includes a first upper conductive member CU1 to a 10th upper conductive member CU10. Specifically, the upper conductive member CU includes: a bonding surface CS exposed on the surface of the fixed support 1; an external terminal portion TM that is exposed from the lower portion of the leg portion 1D of the fixed support 1 and extending downward thereof; and a pulling portion RT provided between the bonding surface CS and the external terminal portion TM and embedded in the fixed support 1. More specifically, the first upper conductive member CU1 to the 10th upper conductive member CU10 include, respectively, bonding surface CS1 to a 10th bonding surface CS10, a first external terminal portion TMI to a 10th external terminal portion TM10, and a first pulling portion RT1 to a 10th pulling portion RT10. In FIG. 4, for clarity, only the 10th upper conductive member CU10 is denoted by the upper numerals “CS”, “RT”, and “TM” before the numerals “CS10”, “RT10”, and “TM10”. The numerals “RT1” to “RT9” are not illustrated.

The lower conductive member CD is a conductive member attached to the lower surface of the fixed support 1 and includes a first lower conductive member CD1 to a fifth lower conductive member CD5.

In the illustrated example, the fixed-side metal member 5F is fixed to the upper surface of the fixed support 1 as illustrated in the lower figure in FIG. 5. Specifically, the first bonding surface CS1 to the fourth bonding surface CS4 are exposed to the upper surface of the base 1B of the fixed support 1 as illustrated in the upper figure in FIG. 5.

More specifically, as illustrated in FIG. 5, two first through holes 5H1 through which two cylindrical projections 1P formed to project upward of the upper surface of the base 1B of the fixed support 1 are inserted, are formed in each of the fixed-side metal members 5F. In the illustrated example, bonding of the fixed support 1 to each of the fixed-side metal members 5F is performed by applying heat caulking or cold caulking to the two projections 1P inserted into the two first through holes 5H1. However, the bonding between the fixed support 1 and the fixed-side metal member 5F may be performed by an adhesive.

A second through-hole 5H2 is formed in the central portion of each of the fixed-side metal members 5F as illustrated in the lower figure in FIG. 5. The second through-hole 5H2 is used for bonding each of the fixed-side metal members 5F to the bonding surface CS of the upper conductive member CU. In the illustrated example, bonding of each of the fixed-side metal members 5F to the upper conductive member CU is performed by laser welding. However, bonding of each of the fixed-side metal members 5F to the upper conductive member CU may be performed by soldering or by using a conductive adhesive.

More specifically, the first fixed-side terminal plate 5F1 to the fourth fixed-side terminal plate 5F4 are respectively bonded together by laser welding to the first bonding surface CS1 to a fourth bonding surface CS4, that are mounted on the base 1B and exposed on the upper surface of the base 1B.

As illustrated in the central figure of FIG. 6, a first through hole 6H1 and a second through hole 6H2 are formed in each of a first base fixing part 6N1 and a second base fixing part 6N2 of the flexible metal member 6. The first through hole 6H1 is used when the base fixing part 6N and the fixed support 1 are bonded together. In the illustrated example, the bonding of the base fixing part 6N to the fixed support 1 is realized by applying heat caulking or cold caulking to a projection 10 inserted into the first through hole 6H1. In the illustrated example, the projection 10 is a cylinder formed to project downward of the lower surface of the base 1B of the fixed support 1, as illustrated in the upper figure of FIG. 6. However, the bonding between the base fixing part 6N and the fixed support 1 may be realized by an adhesive. The second through hole 6H2 is used when the base fixing part 6N and the upper conductive member CU embedded in the fixed support 1 are bonded. In the illustrated example, the bonding between the base fixing part 6N and the upper conductive member CU is realized by laser welding. The bonding between the base fixing part 6N and the upper conductive member CU may be performed by soldering or by using a conductive adhesive.

Specifically, as illustrated in FIG. 6, the bonding of each of the first base fixing part 6N1 and the second base fixing part 6N2 to the fixed support 1 is realized by applying heat caulking or cold caulking to the projection 10 inserted into the first through hole 6H1. The bonding (welding) between the first base fixing part 6N1 and the fifth bonding surface CS5 of the fifth upper conductive member CU5 is realized by irradiating the second through hole 6H2 with a laser. The second through hole 6H2 formed in the second base fixing part 6N2 is not bonded to the upper conductive member CU.

As illustrated in the lower figure in FIG. 6, the first through hole H1 and the second through hole H2 are formed in each of the lower conductive members CD (the first lower conductive member CD1 to the fifth lower conductive member CD5). The first through hole H1 is used to bond the lower conductive member CD and the fixed support 1 together. In the illustrated example, bonding together of the lower conductive member CD and the fixed support 1 is realized by applying heat caulking or cold caulking to a projection 1R inserted into the first through hole H1. In the illustrated example, the projection 1R is a cylindrical portion formed to project downward of the lower surface of the leg portion 1D of the fixed support 1, as illustrated in the upper figure of FIG. 6. However, the bonding between the lower conductive member CD and the fixed support 1 may be realized by an adhesive. The second through hole H2 is used when the lower conductive member CD and the upper conductive member CU embedded in the fixed support 1 are bonded together. In the illustrated example, the bonding between the lower conductive member CD and the upper conductive member CU is realized by laser welding. The bonding between the lower conductive member CD and the upper conductive member CU may be realized by soldering or by using a conductive adhesive.

More specifically, as illustrated in FIG. 6, the bonding of each of the first lower conductive member CD1 to the fifth lower conductive member CD5 with the fixed support 1 is realized by applying heat caulking or cold caulking to the projection 1R inserted into the first through hole H1. Further, the bonding (welding) of the first lower conductive member CD1 with the sixth bonding surface CS6 of the sixth upper conductive member CU6 is realized by irradiating the second through hole H2 with a laser. The same applies to the bonding (welding) of the second lower conductive member CD2 to the seventh bonding surface CS7 of the seventh upper conductive member CU7, the bonding (welding) of the third lower conductive member CD3 to the eighth bonding surface CS8 of the eighth upper conductive member CU8, the bonding (welding) of the fourth lower conductive member CD4 to a ninth bonding surface CS9 of the ninth upper conductive member CU9, and the bonding (welding) of the fifth lower conductive member CD5 to the 10th bonding surface CS10 of the 10th upper conductive member CU10.

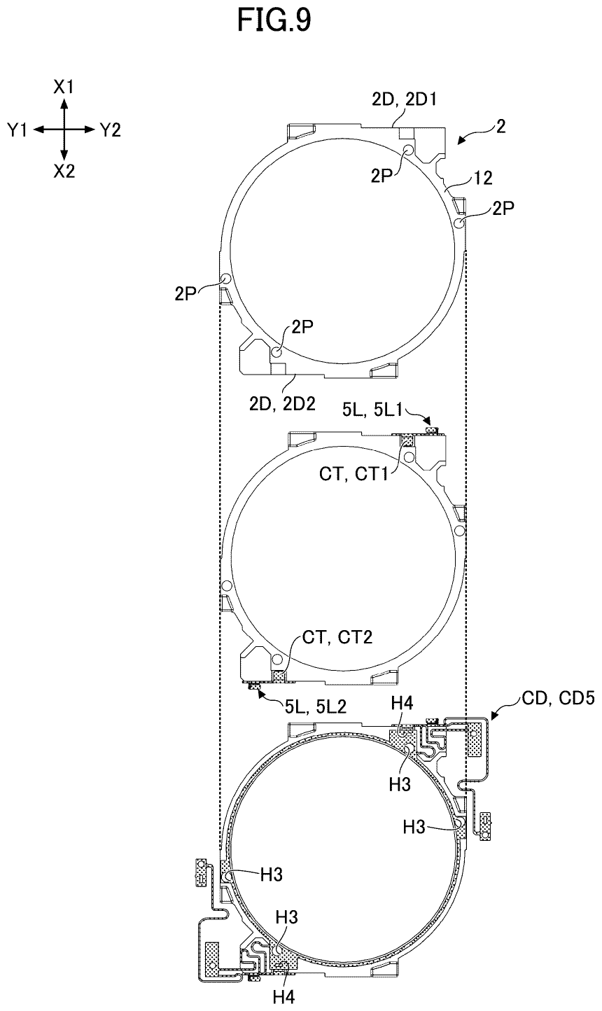

Next, with reference to FIGS. 7 to 9, details of the lens holder 2 as the movable side member MB will be described. FIG. 7 is a perspective view illustrating the lens holder 2 to which a lens-side metal member 5L, the second magnetic member 10, the yoke 11, and the fifth lower conductive member CD5 are attached. More specifically, the upper figure (above the block arrow) of FIG. 7 is a perspective view illustrating the lens holder 2, the lens-side metal member 5L, the second magnetic member 10, the yoke 11, and the fifth lower conductive member CD5. The lower view (below the block arrow) of FIG. 7 is a perspective view illustrating the lens holder 2 to which the lens-side metal member 5L, the second magnetic member 10, the yoke 11, and the fifth lower conductive member CD5 are attached. FIG. 8 is a top view illustrating the lens holder 2. Specifically, the upper figure of FIG. 8 is a top view illustrating the lens holder 2 in a state in which no other members are attached. The lower figure of FIG. 8 is a top view illustrating the lens holder 2 in a state in which the lens-side metal member 5L, the second magnetic member 10, and the yoke 11 are attached. FIG. 9 is a bottom view illustrating the lens holder 2. Specifically, the upper figure of FIG. 9 is a bottom view illustrating the lens holder 2 in a state in which no other member is attached, the central figure of FIG. 9 is a bottom view illustrating the lens holder 2 in a state in which the lens-side metal member 5L is attached, and the lower figure of FIG. 9 is a bottom view illustrating the lens holder 2 in a state in which the fifth lower conductive member CD5 is further attached. For clarity, in the lower figure of FIG. 8, a dotted pattern is applied to the lens-side metal member 5L, the second magnetic member 10, and the yoke 11. In the central figure of FIG. 9, a dotted pattern is applied to the lens-side metal member 5L, and in the lower figure of FIG. 9, the dotted pattern is applied to the lens-side metal member 5L and the fifth lower conductive member CD5.

As illustrated in FIG. 7, a side surface to which the lens-side metal member 5L is attached is formed on the pedestal portion 2D of the lens holder 2. In the illustrated example, as illustrated in the lower figure in FIG. 8, the first lens-side terminal plate 5L1 is fixed to the front surface of the first pedestal portion 2D1, and the second lens-side terminal plate 5L2 is fixed to the rear surface of the second pedestal portion 2D2.

Specifically, the bonding between the lens holder 2 to each of the corresponding lens-side metal member 5L is realized by applying an adhesive to a projection (a projection formed on the side surface of the pedestal portion 2D) not illustrated inserted into the third through-hole 5H3. However, the bonding between the lens holder 2 and the lens-side metal member 5L may be realized by other methods. For example, the lens-side metal member 5L may be bonded and fixed to the side surface of the pedestal portion 2D, where no projection is formed.

A recess 2R for receiving the second magnetic member 10 and the yoke 11 is formed in the pedestal portion 2D of the lens holder 2. In the illustrated example, as illustrated in the upper figure of FIG. 8, the recess 2R includes a first recess 2R1 for receiving a second front magnetic member 10F and a front yoke 11F that is formed at the right end of the first pedestal portion 201, and a second recess 2R2 for receiving a second rear magnetic member 10B and a rear yoke 11B formed at the left end of the second pedestal portion 2D2. Each of the first recess 2R1 and the second recess 2R2 includes a wide portion WP for receiving the yoke 11 attached to the second magnetic member 10 by an adhesive, and a narrow portion NP for receiving only the second magnetic member 10. The narrow portion NP of the first recess 2R1 forms a slip-off preventer for preventing the second front magnetic member 10F and the front yoke 11F, which are attracted to the right by the first front magnetic member 9F, from falling out to the right. Similarly, the narrow portion NP of the second recess 2R2 forms a slip-off preventer for preventing the second rear magnetic member 10B and the rear yoke 11B, which are attracted to the left by the first rear magnetic member 9B, from falling out to the left.

As illustrated in the central figure of FIG. 9, a bonding surface CT is formed on the lens-side metal member 5L. The bonding surface CT is used for bonding together the lens-side metal member 5L and a fifth lower conductive member CD5. Specifically, the first lens-side terminal plate 5L1 includes a first bonding surface CT1, and the second lens-side terminal plate 5L2 includes a second bonding surface CT2.

Further, the fifth lower conductive member CD5 includes a third through hole H3 and a fourth through hole H4, as illustrated in the lower figure of FIG. 9. The third through hole H3 is used to bond together the fifth lower conductive member CD5 and the lens holder 2. In the illustrated example, bonding together of the fifth lower conductive member CD5 and the lens holder 2 is realized by applying heat caulking or cold caulking to a projection 2P inserted into the third through hole H3. In the illustrated example, the projection 2P is a cylindrical portion formed to project downward of the lower surface of the cylinder 12 of the lens holder 2, as illustrated in the upper figure of FIG. 9. However, the bonding between the fifth lower conductive member CD5 and the lens holder 2 may be realized by an adhesive.

The fourth through hole H4 is used when the fifth lower conductive member CD5 and the lens-side metal member 5L are bonded. In the illustrated example, the bonding together of the fifth lower conductive member CD5 and the lens-side metal member 5L is realized by laser welding. However, the bonding together of the fifth lower conductive member CD5 and the lens-side metal member 5L may be performed by soldering or by using a conductive adhesive.

Specifically, as illustrated in FIG. 9, the bonding (welding) of the fifth lower conductive member CD5 to the first bonding surface CT1 of the first lens-side terminal plate 5L1 is realized by irradiating the fourth through hole H4 with a laser. The same applies to the bonding (welding) of the fifth lower conductive member CD5 to the second bonding surface CT2 of the second lens-side terminal plate 5L2.

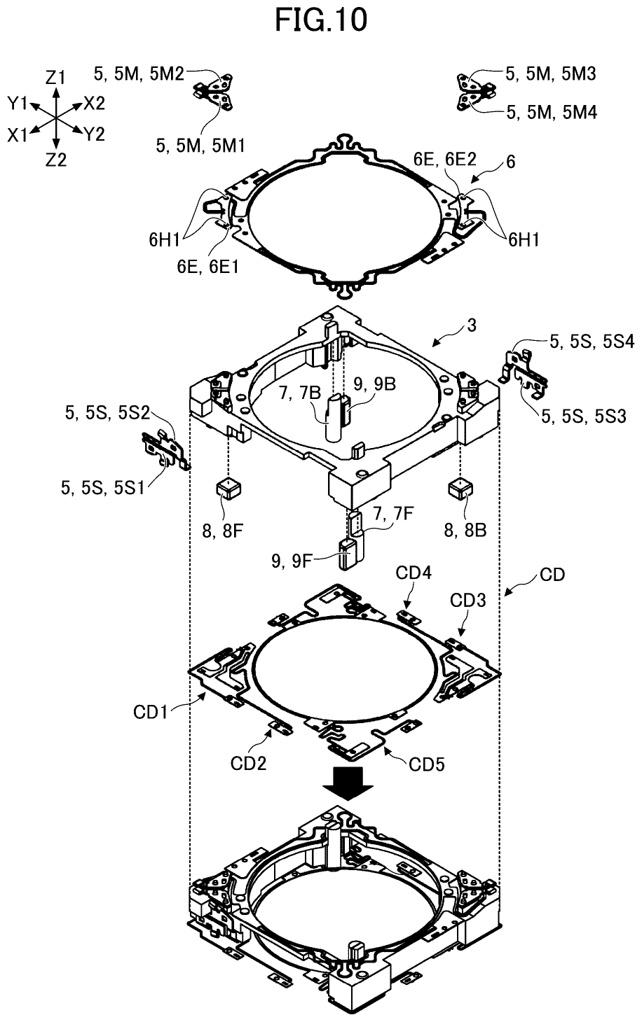

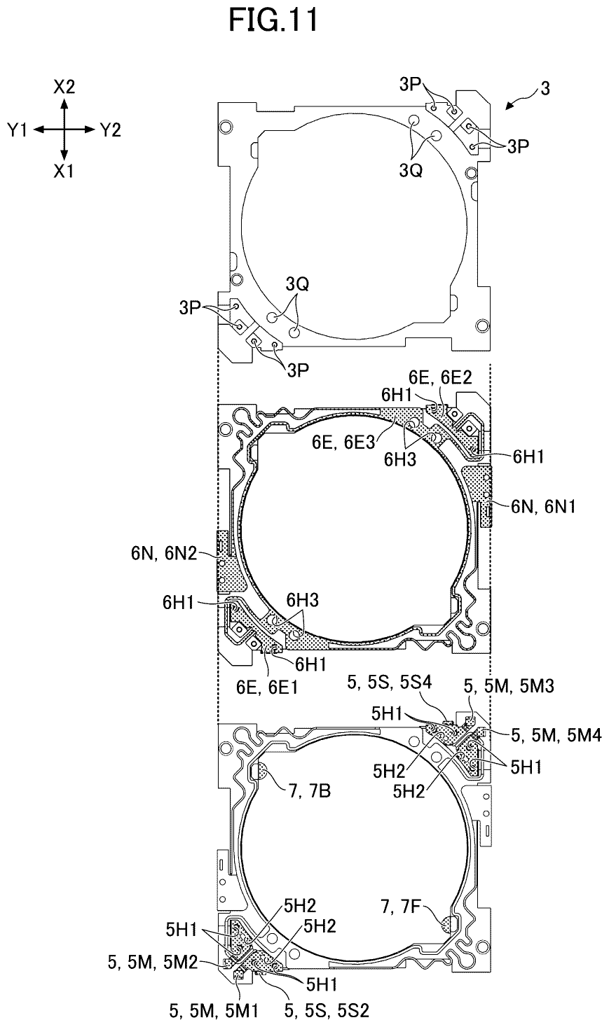

Next, the details of the support 3 as the movable side member MB will be described with reference to FIGS. 10 to 12. FIG. 10 is a perspective view illustrating the support 3 to which the movable-side metal member 5M, the support-side metal member 5S, the flexible metal member 6, the guide member 7, the magnet 8, the first magnetic member 9, and the lower conductive CD member are attached. Specifically, the upper figure of FIG. 10 (the figure above the block arrow) is a perspective view illustrating the support 3, the movable-side metal member 5M, the support-side metal member 5S, the flexible metal member 6, the guide member 7, the magnet 8, the first magnetic member 9, and the lower conductive member CD. The lower figure of FIG. 10 (the figure below the block arrow) is a perspective view illustrating the movable-side metal member 5M, the support-side metal member 5S, the flexible metal member 6, the guide member 7, the magnet 8, the first magnetic member 9, and the support 3 to which the lower conductive member CD is attached. FIG. 11 is a top view illustrating the support 3. Specifically, the upper figure of FIG. 11 is a top view illustrating the support 3 in a state in which no other members are attached, the central figure of FIG. 11 is a top view illustrating the support 3 in a state in which the flexible metal member 6 is attached, and the lower figure of FIG. 11 is a top view illustrating the support 3 in a state in which the movable-side metal member 5M, the support-side metal member 5S, and the guide member 7 are further attached. FIG. 12 is a bottom view illustrating the support 3. Specifically, the upper figure of FIG. 12 is a bottom view illustrating the support 3 in a state in which no other members are attached, the central figure of FIG. 12 is a bottom view illustrating the support 3 in a state in which the support-side metal member 5S, the guide member 7, the magnet 8, and the first magnetic member 9 are attached. The lower figure of FIG. 12 is a bottom view illustrating the support 3 in a state in which the lower conductive member CD is further attached. For clarity, in the central figure of FIG. 11, a dotted pattern is applied to the flexible metal member 6, and in the lower figure of FIG. 11, a dotted pattern is applied to the movable-side metal member 5M, the support-side metal member 5S, and the guide member 7. In the central figure of FIG. 12, a dotted pattern is applied to the support-side metal member 5S, the guide member 7, the magnet 8, and the first magnetic member 9, and in the lower figure of FIG. 12, a dotted pattern is applied to the lower conductive member CD.

As illustrated in the central figure of FIG. 11, a third through hole 6H3 is formed in the third support fixing part 6E3 of the support fixing part 6E of the flexible metal member 6. The third through hole 6H3 is used to bond the third support fixing part 6E3 and the support 3. In the illustrated example, the bonding together of the third support fixing part 6E3 and the support 3 is realized by applying heat caulking or cold caulking to a projection 30 inserted into the third through hole 6H3. In the illustrated example, the projection 30 is a cylinder formed to project upward of the upper surface of the support 3 as illustrated in the upper figure of FIG. 11. However, the bonding between the third support fixing part 6E3 and the support 3 may be realized by an adhesive.

As illustrated in the central figure of FIG. 11, the first support fixing part 6E1 and the second support fixing part 6E2 that are in the support fixing part 6E of the flexible metal member 6 each include two first through holes 6H1 through which two cylindrical projections 3P formed so as to project upward of the upper surface of the support 3 are inserted. In addition, two first through holes 5H1 through which two projections 3P are inserted are formed in each of the movable-side metal members 5M, as illustrated in the lower figure of FIG. 11. In the illustrated example, the bonding together of the support 3, the movable-side metal member 5M, and the support fixing part 6E is realized by applying heat caulking or cold caulking to the projections 3P through each of the first through holes 5H1 and the first through holes 6H1. However, the bonding together of the support 3, the movable-side metal member 5M, and the support fixing part 6E may be realized by an adhesive.

Specifically, as illustrated in FIG. 11, the bonding of the first support fixing part 6E1 to the first movable-side terminal plate 5M1 and the second movable-side terminal plate 5M2 to the support 3 is realized by applying heat caulking or cold caulking to the projections 3P inserted into the first through hole 5H1 and the first through hole 6H1, respectively. Similarly, the bonding of the second support fixing part 6E2 to the third movable-side terminal plate 5M3 and the fourth movable-side terminal plate 5M4 to the support 3 is realized by applying heat caulking or cold caulking to the projections 3P inserted into the first through hole 5H1 and the first through hole 6H1, respectively.

In addition, the second through hole 5H2 is formed in the center of each of the movable-side metal members 5M, as illustrated in the lower figure in FIG. 11. The second through hole 5H2 is used for bonding together the movable-side metal member 5M and the support fixing part 6E of the flexible metal member 6. In the illustrated example, bonding (laser welding) between the movable-side metal member 5M and the support fixing part 6E is realized by irradiating the second through hole 5H2 with a laser. However, the bonding (laser welding) between the movable-side metal member 5M and the support fixing part 6E may be performed by soldering or by using a conductive adhesive.

More specifically, the bonding (laser welding) of the first movable-side terminal plate 5M1 and the second movable-side terminal plate 5M2 with the first support fixing part 6E1 is realized by irradiating the second through hole 5H2 with a laser. The same applies to the bonding (laser welding) of the third movable-side terminal plate 5M3 and the fourth movable-side terminal plate 5M4 with the second support fixing part 6E2.

As illustrated in the upper figure of FIG. 12, a groove 3T for receiving the guide member 7, a recess 3U for receiving the magnet 8, and a recess 3W for receiving the first magnetic member 9 are formed on the lower surface of the support 3. In the illustrated example, as illustrated in the upper figure of FIG. 12, the groove 3T includes a first groove 3T1 formed in the right front part of the support 3 for receiving the front guide member 7F, and a second groove 3T2 formed in the left rear part of the support 3 for receiving the rear guide member 7B. The recess 3U also includes a first recess 301 formed in the left front part of the support 3 for receiving the front magnet 8F, and a second recess 302 formed in the right rear part of the support 3 for receiving the rear magnet 8B. The recess 3W also includes a first recess 3W1 formed in the right front part of the support 3 for receiving the first front magnetic member 9F, and a second recess 3W2 formed in the left rear part of the support 3 for receiving the first rear magnetic member 9B. The first recess 3W1 and the second recess 3W2 each includes a wide portion WP and a narrow portion NP for receiving the hexagonal semi-octagonal columnar (nearly columnar) first magnetic member 9. The narrow portion NP of the first recess 3W1 forms a slip-off preventer for preventing the first front magnetic member 9F attracted to the left by the second front magnetic member 10F (see the lower figure of FIG. 8) from falling out to the left. Similarly, the narrow portion NP of the second recess 3W2 forms a slip-off preventer for preventing the first rear magnetic member 9B attracted to the right by the second rear magnetic member 10B (see the lower figure of FIG. 8) from falling out to the right. The guide member 7, the magnet 8, and the first magnetic member 9 are fixed to the support 3 by an adhesive.

Further, the lower conductive member CD includes a fifth through hole H5 and a sixth through hole H6, as illustrated in the lower figure in FIG. 12. The fifth through hole H5 is used for bonding together the lower conductive member CD and the 3. In the illustrated example, bonding support together of the lower conductive member CD and the support 3 is realized by applying heat caulking or cold caulking to a projection 3R inserted into the fifth through hole H5. In the illustrated example, the projection 3R is a cylindrical portion formed to project downward of the lower surface of the support 3, as illustrated in the upper figure of FIG. 12. However, the bonding between the lower conductive member CD and the support 3 may be realized by an adhesive.

The sixth through hole H6 is used for bonding together the lower conductive member CD and the support-side metal member 5S. In the illustrated example, bonding (laser welding) of the lower conductive member CD and the support-side metal member 5S is realized by irradiating the sixth through hole H6 with a laser. However, bonding together of the lower conductive member CD and the support-side metal member 5S may be performed by soldering or by using a conductive adhesive.

Specifically, as illustrated in FIG. 12, bonding (welding) of the first lower conductive member CD1 and the first support-side terminal plate 5S1 is realized by irradiating the sixth through hole H6 with a laser. The same applies to bonding (welding) of the second lower conductive member CD2 and the second support-side terminal plate 5S2, bonding (welding) of the third lower conductive member CD3 and the third support-side terminal plate 5S3, and bonding (welding) of the fourth lower conductive member CD4 and the fourth support-side terminal plate 5S4.

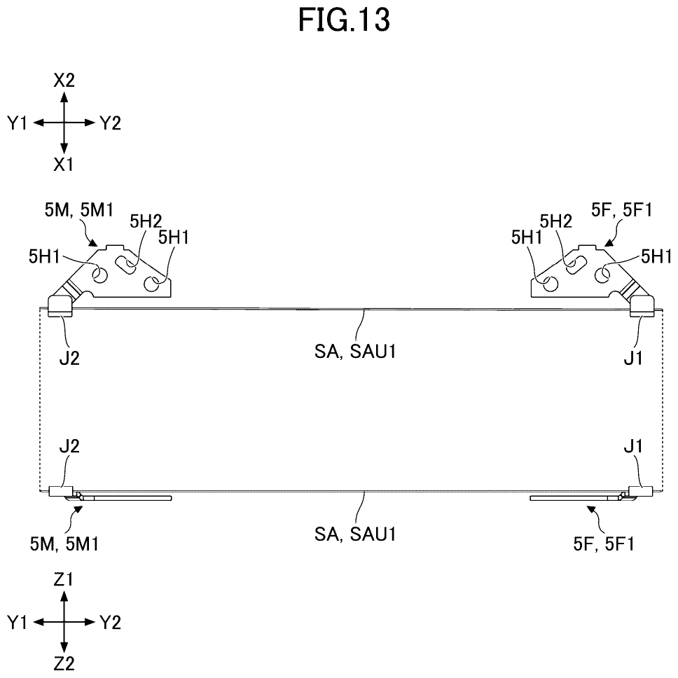

Next, an upper shape memory alloy wire SAU attached to the metal member 5 will be described with reference to FIG. 13. FIG. 13 illustrates an arrangement example of the first movable-side terminal plate 5M1, the first fixed-side terminal plate 5F1, the first upper wire SAU1. Specifically, an upper figure of FIG. 13 is a view illustrating the first upper wire SAU1 attached to each of the first movable-side terminal plate 5M1 and the first fixed-side terminal plate 5F1 when viewed from the upper side (Z1 side). The lower figure of FIG. 13 is a view illustrating the first upper wire SAU1 attached to each of the first movable-side terminal plate 5M1 and the first fixed-side terminal plate 5F1 when viewed from the front side (X1 side). The positional relationship of each member shown in FIG. 13 corresponds to the positional relationship when the lens drive device 101 is assembled and current is supplied to the upper shape memory alloy wire SAU. In FIG. 13, illustrations of other members are omitted for clarity. The following description referring to FIG. 13 may be applied to the first upper wire SAU1, but also to the second upper wire SAU2 to the fourth upper wire SAU4.

Specifically, one end of the first upper wire SAU1 is fixed to the first fixed-side terminal plate 5F1 at a holder J1 of the first fixed-side terminal plate 5F1, and the other end of the first upper wire SAU1 is fixed to the first movable-side terminal plate 5M1 at a holder J2 of the first movable-side terminal plate 5M1.

The holder J1 is formed by bending a part of the fixed-side first terminal plate 5F1. Specifically, the holder J1 is formed by bending a part of the first fixed-side terminal plate 5F1 with an end (one end) of the first upper wire SAU1 sandwiched therebetween. The end (one end) of the first upper wire SAU1 is fixed to the holder J1 by welding. The same applies to the holder J2.

As described above, one end in each of the first upper wire SAU1 to the fourth upper wire SAU4 is fixed to the first fixed-side terminal plate 5F1 to the fourth fixed-side terminal plate 5F4, respectively. The other end in each of the first upper wire SAU1 to the fourth upper wire SAU4 is fixed to the first movable-side terminal plate 5M1 to the fourth movable-side terminal plate 5M4, respectively. The fixed support 1 to which the first fixed-side terminal plate 5F1 to the fourth fixed-side terminal plate 5F4 are attached is configured to function as a wire support. The support 3 to which the first movable-side terminal plate 5M1 to the fourth movable-side terminal plate are attached is configured to function as a movable side member MB. With this configuration, the support 3 is supported, by the first upper wire SAU1 to the fourth upper wire SAU4, and the fixed support 1, in a state so as to be movable at least in the X-axis direction and the Y-axis direction that are the directions perpendicular to the optical axis OA.

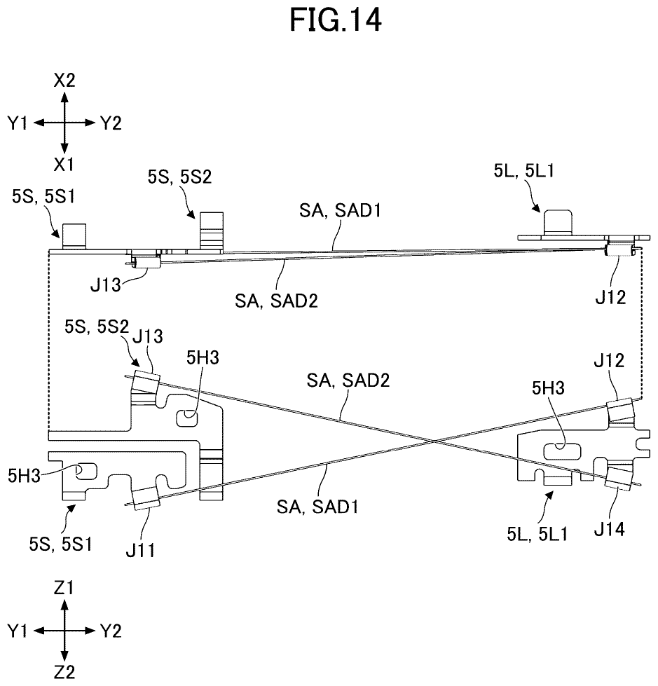

Next, with reference to FIG. 14, the lower shape memory alloy wire SAD attached to the metal member 5 will be described. FIG. 14 is a view illustrating an arrangement example of the first lens-side terminal plate 5L1, the first support-side terminal plate 5$1, the second support-side terminal plate 5S2, the first lower wire SAD1, and the second lower wire SAD2. Specifically, the upper figure of FIG. 14 is a view illustrating the first lower wire SAD1 attached to the first lens-side terminal plate 5L1 and the first support-side terminal plate 5S1, and the second lower wire SAD2 attached to the first lens-side terminal plate 5L1 and the second support-side terminal plate 5S2, when viewed from the upper side (Z1 side). The lower figure of FIG. 14 is a view illustrating the first lower wire SAD1 attached to the first lens-side terminal plate 5L1 and the first support-side terminal plate 5$1, and the second lower wire SAD2 attached to the first lens-side terminal plate 5L1 and the second support-side terminal plate 5S2, when viewed from the front side (X1 side). The positional relationship of each member shown in FIG. 14 corresponds to the positional relationship when the lens drive device 101 is assembled and current is supplied to the lower shape memory alloy wire SAD. In FIG. 14, illustrations of other members are omitted for clarity. Further, the following description with reference to FIG. 14 relates to a combination of the first lower wire SAD1 and the second lower wire SAD2, but may also apply to a combination of the third lower wire SAD3 and the fourth lower wire SAD4.

Specifically, one end of the first lower wire SAD1 is fixed to the first support-side terminal plate 5S1 at a holder J11 of the first support-side terminal plate 5$1. The other end of the first lower wire SAD1 is fixed to the upper end of the first lens-side terminal plate 5L1 at a holder J12 of the first lens-side terminal plate 5L1. Further, one end of the second lower wire SAD2 is fixed to the second support-side terminal plate 52 at a holder J13 of the second support-side terminal plate 5S2. The other end of the second lower wire SAD2 is fixed to the lower end of the first lens-side terminal plate 5L1 at a holder J14 of the first lens-side terminal plate 5L1.

The holder J11 is formed by bending a part of the first support-side terminal plate 5S1. Specifically, the holder J11 is formed by bending a part of the first support-side terminal plate 5S1 while the end (one end) of the first lower wire SAD1 is sandwiched. The end (one end) of the first lower wire SAD1 is fixed to the holder J11 by welding. The same applies to the holder J12 to the holder J14.

As described above, one end in each of the first lower wire SAD1 to the fourth lower wire SAD4 is fixed to the first support-side terminal plate 5S1 to the fourth support-side terminal plate 5$4, and the other end in each of the first lower wire SAD1 and the second lower wire SAD2 is fixed to the first lens-side terminal plate 5L1. The other end in each of the third lower wire SAD3 and the fourth lower wire SAD4 is fixed to the second lens-side terminal plate 5L2. The support 3 to which the first support-side terminal plate 5$1 to the fourth support-side terminal plate 5$4 are attached is configured to function as a wire support. The lens holder 2 to which the first lens-side terminal plate 5L1 and the second lens-side terminal plate 5L2 are attached is configured to function as a movable side member MB. With this configuration, the lens holder 2 is supported by the first lower wire SAD1 to fourth lower wire SAD4 and the support 3, in a state in which the lens holder 2 can move in the Z-axis direction, which is at least a direction parallel to the optical axis OA. A third through-hole 5H3, which is used for fixing the support-side metal member 5S to the side surface of the support 3, is formed in the support-side metal member 5S, in the same manner as the lens-side metal member 5L. An adhesive for bonding together the support 3 and the support-side metal member 5S may be applied through the third through-hole 5H3.

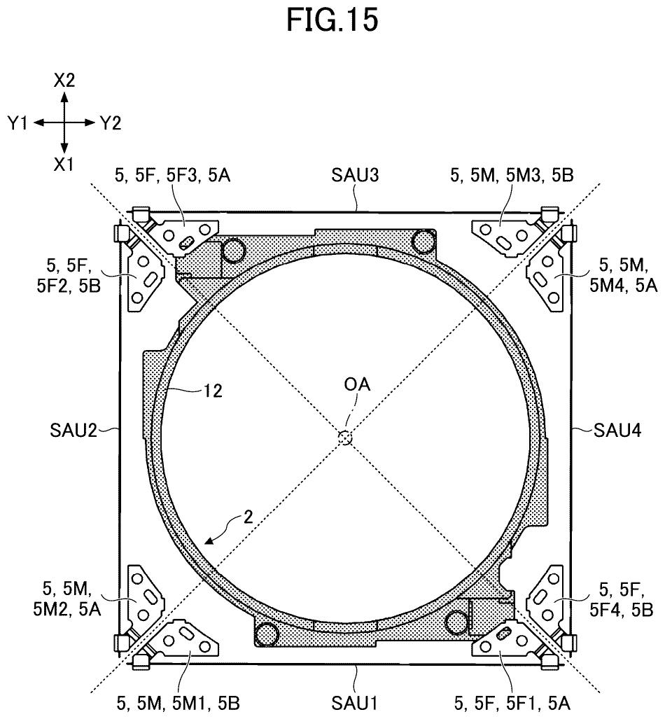

Next, with reference to FIG. 15, a positional relationship between the fixed-side metal member 5F, the movable-side metal member 5M, the upper shape memory alloy wire SAU, and the lens holder 2 will be described. FIG. 15 is a top view illustrating the fixed-side metal member 5F, the movable-side metal member 5M, the upper shape memory alloy wire SAU, and the lens holder 2. In FIG. 15, a dotted pattern is applied to the lens holder 2 for clarity.

As illustrated in FIG. 15, the upper shape memory alloy wire SAU includes a first upper wire SAU1 to a fourth upper wire SAU4 arranged to surround the cylinder 12 of the lens holder 2 in a plan view along the optical axis direction. One end of the first upper wire SAU1 is fixed to the first fixed-side terminal plate 5F1, and the other end is fixed to the first movable-side terminal plate 5M1. Similarly, one end of the second upper wire SAU2 is fixed to the second fixed-side terminal plate 5F2, and the other end is fixed to the second movable-side terminal plate 5M2. Further, one end of the third upper wire SAU3 is fixed to the third fixed-side terminal plate 5F3, and the other end is fixed to the third movable-side terminal plate 5M3. Further, one end of the fourth upper wire SAU4 is fixed to the fourth fixed-side terminal plate 5F4, and the other end is fixed to the fourth movable-side terminal plate 5M4.

Thus, the upper shape memory alloy wire SAU is supported by four fixed-side metal members 5F and four movable-side metal members 5M. From another viewpoint, the upper shape memory alloy wire SAU is supported by four first shape metal members 5A and four second shape metal members 5B. The four first shape metal members 5A are identical parts having the same shape and include a first fixed-side terminal plate 5F1, a second movable-side terminal plate 5M2, a third fixed-side terminal plate 5F3, and a fourth movable-side terminal plate 5M4. Similarly, the four second shape metal members 5B are identical parts having the same shape and include a first movable-side terminal plate 5M1, a second fixed-side terminal plate 5F2, a third movable-side terminal plate 5M3, and a fourth fixed-side terminal plate 5F4.

As illustrated in FIG. 15, the adjacent first shape metal member 5A and the second shape metal member 5B have a shape that is linearly symmetric with respect to a broken line crossing the optical axis OA. Each of the first upper wire SAU1 to the fourth upper wire SAU4 is provided between one of the four first shape metal members 5A and corresponding one of the four second shape metal members 5B.

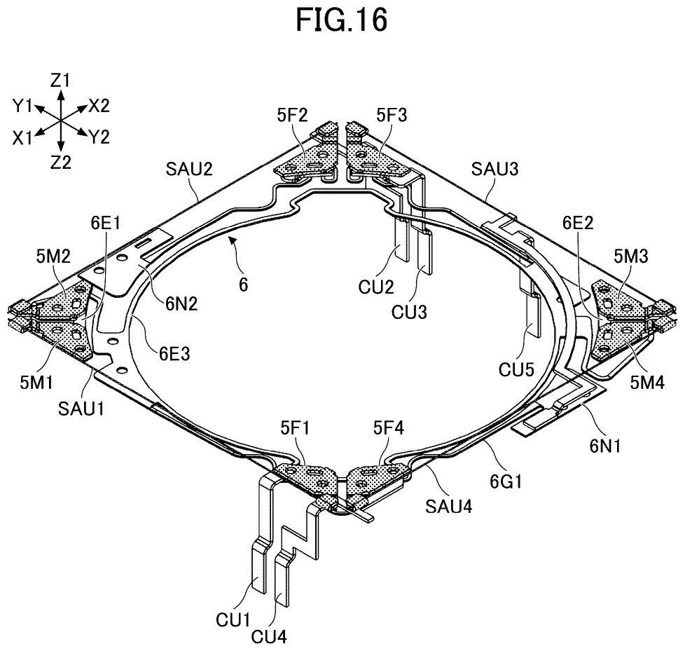

Next, with reference to FIG. 16, a path of a current flowing through the upper shape memory alloy wire SAU will be described. FIG. 16 is a perspective view illustrating the metal member 5 (the first fixed-side terminal plate 5F1 to the fourth fixed-side terminal plate 5F4, and the first movable-side terminal plate 5M1 to the fourth movable-side terminal plate 5M4), the flexible metal member 6, the upper conductive member CU (the first upper conductive member CU1 to the fifth upper conductive member CU5), and the upper shape memory alloy wire SAU (the first upper wire SAU1 to the fourth upper wire SAU4), illustrating a positional relationship between the metal member 5, the flexible metal member 6, the upper conductive member CU, and the upper shape memory alloy wire SAU.

Specifically, when the first upper conductive member CU1 is connected to a high potential and the fifth upper conductive member CU5 is connected to a low potential, the current flows through the first upper conductive member CU1, the first fixed-side terminal plate 5F1, the first upper wire SAU1, the first movable-side terminal plate 5M1, and the flexible metal member 6 (the first support fixing part 6E1, the third support fixing part 6E3, the first flexible arm part 6G1, and the first base fixing part 6N1) to the fifth upper conductive member CU5.

When the second upper conductive member CU2 is connected to a high potential and the fifth upper conductive member CU5 is connected to a low potential, the current flows through the second upper conductive member CU2, the second fixed-side terminal plate 5F2, the second upper wire SAU2, the second movable-side terminal plate 5M2, and the flexible metal member 6 (the first support fixing part 6E1, the third support fixing part 6E3, the first flexible arm part 6G1, and the first base fixing part 6N1) to the fifth upper conductive member CU5.

When the third upper conductive member CU3 is connected to a high potential and the fifth upper conductive member CU5 is connected to a low potential, the current flows through the third upper conductive member CU3, the third fixed-side terminal plate 5F3, the third upper wire SAU3, the third movable-side terminal plate 5M3, and the flexible metal member 6 (the second support fixing part 6E2, the third support fixing part 6E3, the first flexible arm part 6G1, and the first base fixing part 6N1) to the fifth upper conductive member CU5.

When the fourth upper conductive member CU4 is connected to a high potential and the fifth upper conductive member CU5 is connected to a low potential, the current flows through the fourth upper conductive member CU4, the fourth fixed-side terminal plate 5F4, the fourth upper wire SAU4, the fourth movable-side terminal plate 5M4, and the flexible metal member 6 (the second support fixing part 6E2, the third support fixing part 6E3, the first flexible arm part 6G1, and the first base fixing part 6N1) to the fifth upper conductive member CU5.

A controller (not illustrated) that is disposed externally of the lens drive device 101 as described above can individually control contraction in each of the first upper wire SAU1 to the fourth upper wire SAU4 by controlling the current flowing through each of the first upper wire SAU1 to the fourth upper wire SAU4 by, for example, controlling the voltage applied to each of the first upper conductive member CU1 to the fifth upper conductive member CU5. The controller may be disposed in the lens drive device 101. The controller may be a component of the lens drive device 101.

The controller may, for example, move the lens holder 2 along the direction perpendicular to the optical axis OA on the Z1 side (subject side) of an imaging element IS, by using a drive force that is applied along the direction perpendicular to the optical axis OA and generated by the contraction of the upper shape memory alloy wire SAU as the second driver DM2. By moving the lens holder 2 in this manner, the controller may realize an image stabilization function, which is one of lens adjustment functions.

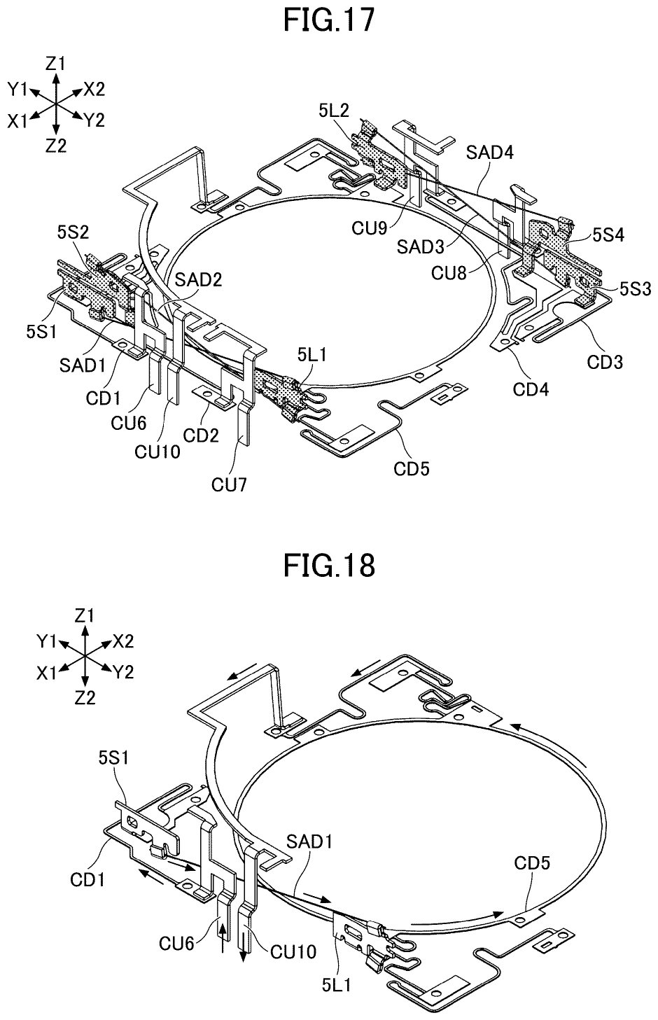

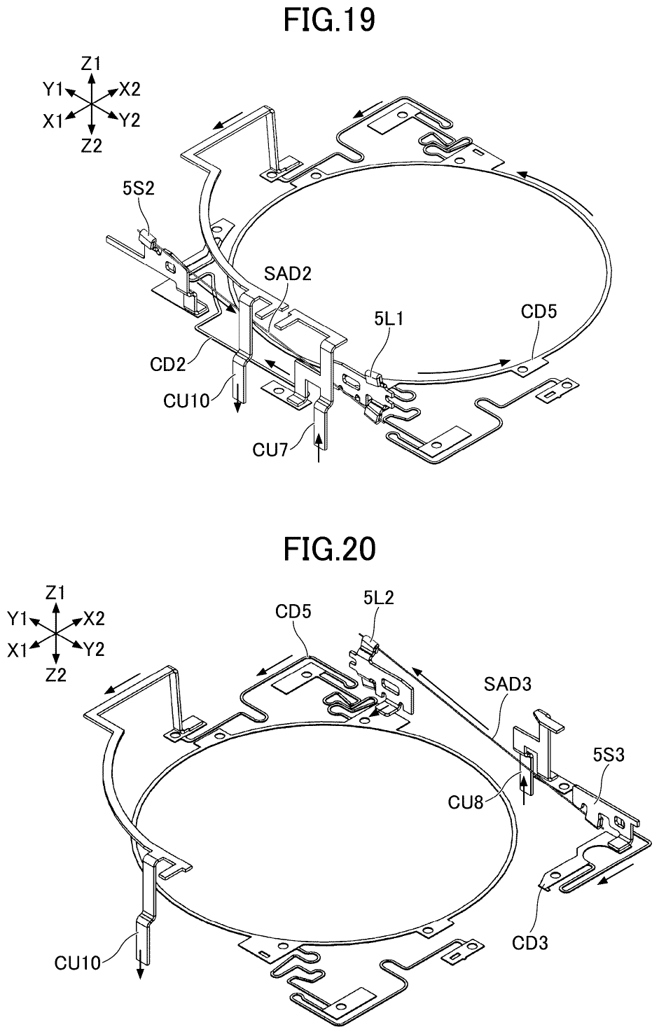

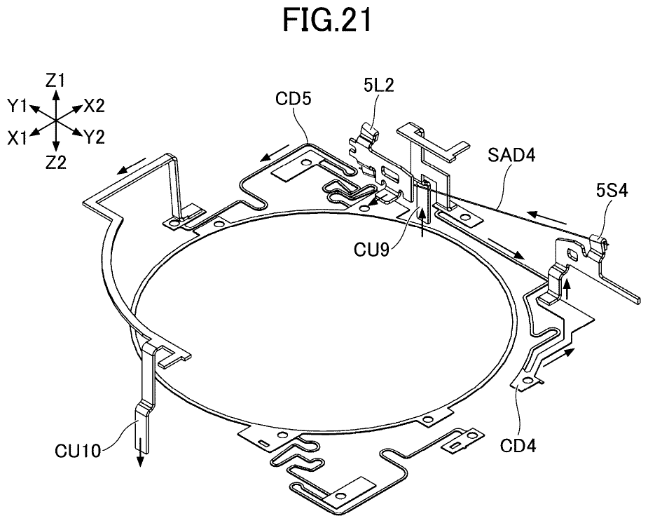

Next, with reference to FIGS. 17 to 21, the path of the current flowing through the lower shape memory alloy wire SAD will be described. FIG. 17 is a perspective view illustrating the metal member 5 (the first support-side terminal plate 5S1 to the fourth support-side terminal plate 584, the first lens-side terminal plate 5L1, and the second lens-side terminal plate 5L2), the upper conductive member CU (the sixth upper conductive member CU6 to the 10th upper conductive member CU10), the lower conductive member CD, and the lower shape memory alloy wire SAD (the first lower wire SAD1 to the fourth lower wire SAD4), illustrating a positional relationship between the metal member 5, the upper conductive member CU, the lower conductive member CD, and the lower shape memory alloy wire SAD. Each of FIGS. 18 to 21 is a perspective view illustrating a portion of the configuration shown in FIG. 17. Specifically, FIG. 18 is a perspective view illustrating a portion related to the first lower wire SAD1, FIG. 19 is a perspective view illustrating a portion related to the second lower wire SAD2, FIG. 20 is a perspective view illustrating a portion related to the third lower wire SAD3, and FIG. 21 is a perspective view illustrating a portion related to the fourth lower wire SAD4.

Specifically, FIG. 18 illustrates an example of a path of current flowing through the first lower wire SAD1 when the sixth upper conductive member CU6 is connected to a high potential and the 10th upper conductive member CU10 is connected to a low potential.

When the sixth upper conductive member CU6 is connected to a high potential and the 10th upper conductive member CU10 is connected to a low potential, current flows through the sixth upper conductive member CU6, the first lower conductive member CD1, the first support-side terminal plate 51, the first lower wire SAD1, the first lens-side terminal plate 5L1, and the fifth lower conductive member CD5, to the 10th upper conductive member CU10, as indicated by arrows in FIG. 18.

FIG. 19 illustrates an example of a path of current flowing through the second lower wire SAD2 when the seventh upper conductive member CU7 is connected to a high potential and the 10th upper conductive member CU10 is connected to a low potential. When the seventh upper conductive member CU7 is connected to a high potential and the 10th upper conductive member CU10 is connected to a low potential, current flows through the seventh upper conductive member CU7, the second lower conductive member CD2, the second support-side terminal plate 5S2, the second lower wire SAD2, the first lens-side terminal plate 5L1, and the fifth lower conductive member CD5, to the 10th upper conductive member CU10, as indicated by arrows in FIG. 19.

FIG. 20 illustrates an example of a path of current flowing through the third lower wire SAD3 when the eighth upper conductive member CU8 is connected to a high potential and the 10th upper conductive member CU10 is connected to a low potential. When the eighth upper conductive member CU8 is connected to a high potential and the 10th upper conductive member CU10 is connected to a low potential, the current flows through the eighth upper conductive member CU8, the third lower conductive member CD3, the third support-side terminal plate 583, the third lower wire SAD3, the second lens-side terminal plate 5L2, and the fifth lower conductive member CD5, to the 10th upper conductive member CU10, as indicated by arrows in FIG. 20.

FIG. 21 illustrates an example of a path of current flowing through the fourth lower wire SAD4 when the ninth upper conductive member CU9 is connected to a high potential and the 10th upper conductive member CU10 is connected to a low potential. When the ninth upper conductive member CU9 is connected to a high potential and the 10th upper conductive member CU10 is connected to a low potential, the current flows through the ninth upper conductive member CU9, the fourth lower conductive member CD4, the fourth support-side terminal plate 5S4, the fourth lower wire SAD4, the second lens-side terminal plate 5L2, and the fifth lower conductive member CD5, to the 10th upper conductive member CU10, as indicated by arrows in FIG. 21.

For example, by controlling the voltage applied to each of the sixth upper conductive member CU6 to the 10th upper conductive member CU10, the controller can individually control the contraction in each of the first lower wire SAD1 to the fourth lower wire SAD4 by controlling the corresponding current flowing through the first lower wire SAD1 to the fourth lower wire SAD4.

The controller may, for example, move the lens holder 2 along the direction parallel to the optical axis OA on the Z1 side (subject side) of the imaging element IS by using the drive force along the direction parallel to the optical axis OA generated by the contraction of the lower shape memory alloy wire SAD as the first driver DM1. By moving the lens holder 2 in this manner, the controller may realize an automatic focus adjustment function, which is one of the lens adjustment functions. Specifically, the controller may move the lens holder 2 in a direction away from the imaging element IS to enable macro photography, and may move the lens holder 2 in a direction approaching the imaging element IS to enable infinity photography.

The controller may also be configured to provide feedback control of the current flowing through the shape memory alloy wire SA by detecting the length (amount of contraction) of the shape memory alloy wire SA based on an output of a sensor that detects a resistance value of the shape memory alloy wire SA.

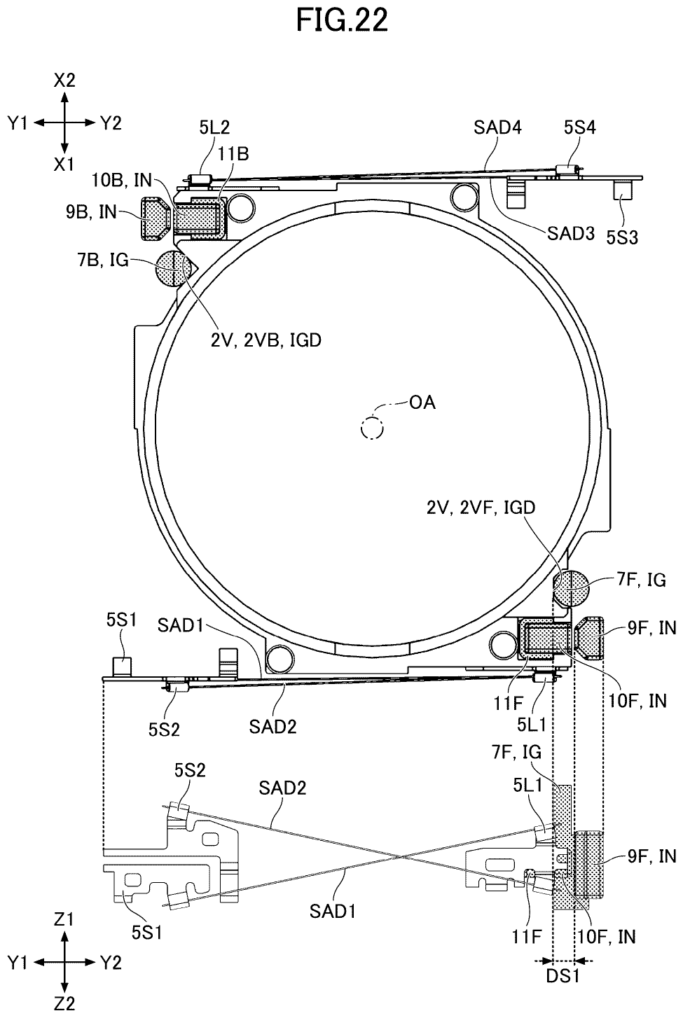

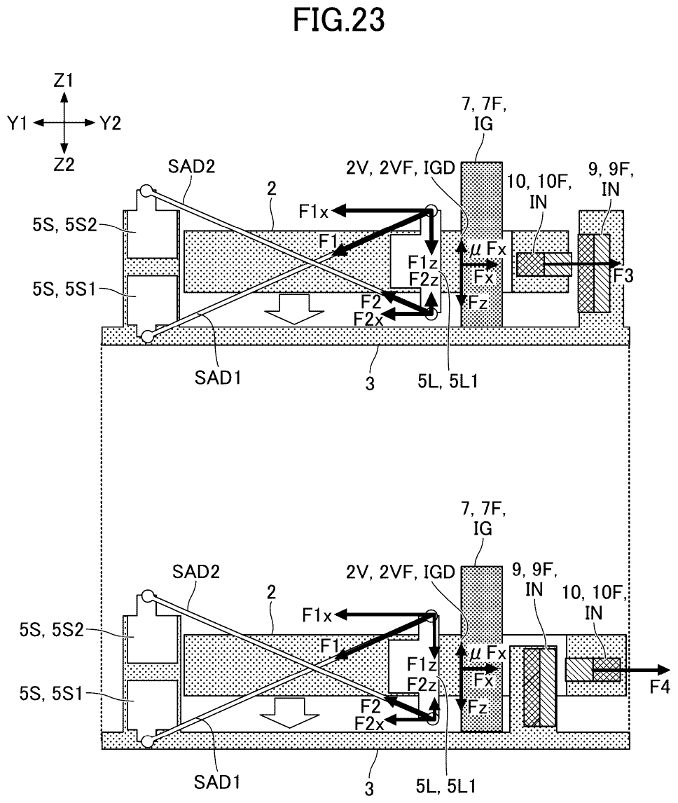

Next, with reference to FIGS. 22 and 23, the inner energizer IN, which is the energizer for exerting a force such that the lens holder 2 and the support 3 push or pull each other, and a relationship between the inner guide IG and the inner guided part IGD guided by the inner guide IG will be described.

FIG. 22 is a view illustrating how the lens holder 2, the support-side metal member 5S, the lens-side metal member 5L, the guide member 7, the first magnetic member 9, the second magnetic member 10, the yoke 11, and the lower shape memory alloy wire SAD are arranged. Specifically, the upper figure of FIG. 22 is a top view illustrating the lens holder 2, the support-side metal member 5S, the lens-side metal member 5L, the guide member 7, the first magnetic member 9, the second magnetic member 10, the yoke 11, and the lower shape memory alloy wire SAD. The lower figure of FIG. 22 is a front view illustrating the support-side metal member 5S, the lens-side metal member 5L, the front guide member 7F, the first front magnetic member 9F, the second front magnetic member 10F, the front yoke 11F, the first lower wire SAD1, and the second lower wire SAD2. In FIG. 22, a dotted pattern is applied to the guide member 7, the first magnetic member 9, the second magnetic member 10, and the yoke 11 for clarity.

FIG. 23 is a front view illustrating the lens holder 2, the support 3, the support-side metal member 5S, the lens-side metal member 5L, the guide member 7, the first magnetic member 9, the second magnetic member 10, and the lower shape memory alloy wire SAD. Specifically, the upper figure of FIG. 23 illustrates a configuration example of the inner energizer IN of the lens drive device 101 according to the above embodiment, and the lower figure of FIG. 23 illustrates another configuration example of the inner energizer IN. More specifically, the inner energizer IN in the upper figure of FIG. 23 is configured to utilize a magnetic attractive force acting between the first magnetic member 9 and the second magnetic member 10, and the inner energizer IN in the lower figure of FIG. 23 is configured to utilize a magnetic repulsive force acting between the first magnetic member 9 and the second magnetic member 10. In FIG. 23, for clarity, dotted patterns are applied to the lens holder 2, the support 3, and the guide member 7, and cross patterns, and diagonal line patterns are applied to the N-pole and S-pole portions of the first magnetic member 9 and the second magnetic member 10 as magnets, respectively. In FIG. 23, each member is schematically represented, and the direction and magnitude of the force acting on each member are represented by arrows. In FIG. 23, for convenience, the Z-axis direction corresponds to the vertical direction, and the Y-axis direction corresponds to the horizontal direction.

More specifically, the block arrows in the upper figure of FIG. 23 indicate a downward movement of the lens holder 2 when contraction force F1 of the first lower wire SAD1 is greater than contraction force F2 of the second lower wire SAD2.

More specifically, the upper figure of FIG. 23 illustrates that the contraction force F1 of the first lower wire SAD1 is decomposed into a downward vertical component F1z and a leftward horizontal component Flx, and the contraction force F2 of the second lower wire SAD2 is decomposed into an upward vertical component F2z and a leftward horizontal component F2x. The upper figure of FIG. 23 also illustrates that the lens holder 2 to which the second front magnetic member 10F is fixed is pulled to the right by a magnetic attractive force F3 acting between the first front magnetic member 9F and the second front magnetic member 10F. The upper figure of FIG. 23 also illustrates that a rightward contact force Fx acts between the front groove 2VF of the lens holder 2 pulled to the right and the front guide member 7F. The contact force Fx corresponds to the resultant force of the leftward horizontal component Flx of the contraction force F1, the leftward horizontal component F2x of the contraction force F2, and the rightward attractive force F3. Static friction force μFx is a force derived by multiplying the contact force Fx by a static friction coefficient μ between the front groove 2VF and the front guide member 7F, and when the magnitude of the drive force Fz by the first driver DM1 (lower shape memory alloy wire SAD) exceeds the magnitude of the static friction force μFx, the lens holder 2 moves in the vertical direction (Z-axis direction). The drive force Fz corresponds to the resultant force of the downward vertical component F1z of the contraction force F1 and the upward vertical component F2z of the contraction force F2. The upper figure of FIG. 23 illustrates the downward movement of the lens holder 2 because the downward drive force Fz exceeds the static friction force μFx. The force applied when the lens holder 2 moves upward is similar to the force applied when the lens holder 2 moves downward, except that the contraction force F1 becomes smaller than the contraction force F2.

The same applies to the case where a magnetic repulsive force acting between the first magnetic member 9 and the second magnetic member 10 is used. Specifically, the block arrows in the lower figure of FIG. 23 illustrate a state in which the lens holder 2 moves downward when the contraction force F1 of the first lower wire SAD1 is greater than the contraction force F2 of the second lower wire SAD2. More specifically, the lower figure of FIG. 23 illustrates a state in which the lens holder 2 to which the second front magnetic member 10F is fixed is pushed to the right by a magnetic repulsive force F4 acting between the first front magnetic member 9F and the second front magnetic member 10F. The manner in which the contraction force F1, the contraction force F2, the contact force Fx, and the drive force Fz are applied is the same as that in the upper figure of FIG. 23.

According to the above-described configuration, the controller can move the lens holder 2 in the Z-axis direction by individually controlling the contraction in each of the first lower wire SAD1 to the fourth lower wire SAD4 by individually flowing a current to each of the first lower wire SAD1 to the fourth lower wire SAD4. Moreover, this configuration brings about the effect that the position of the lens holder 2 in the Z-axis direction can be maintained even when the current supply to each of the first lower wire SAD1 to the fourth lower wire SAD4 is interrupted and the drive force Fz (contraction force F1 and contraction force F2) is lost. This is because the contact force Fx becomes greater than before the loss of the drive force Fz by the amount that the horizontal component F1x of the contraction force F1 and the horizontal component F2x of the contraction force F2 are lost, and becomes nearly equal to the attractive force F3. In other words, the front groove 2VF of the lens holder 2 that is pulled rightward thereof by the attractive force F3 is pressed against the front guide member 7F to generate the contact force Fx, and the static friction force μFx based on the contact force Fx is greater than the drive force Fz (=0) generated by the first driver DM1.

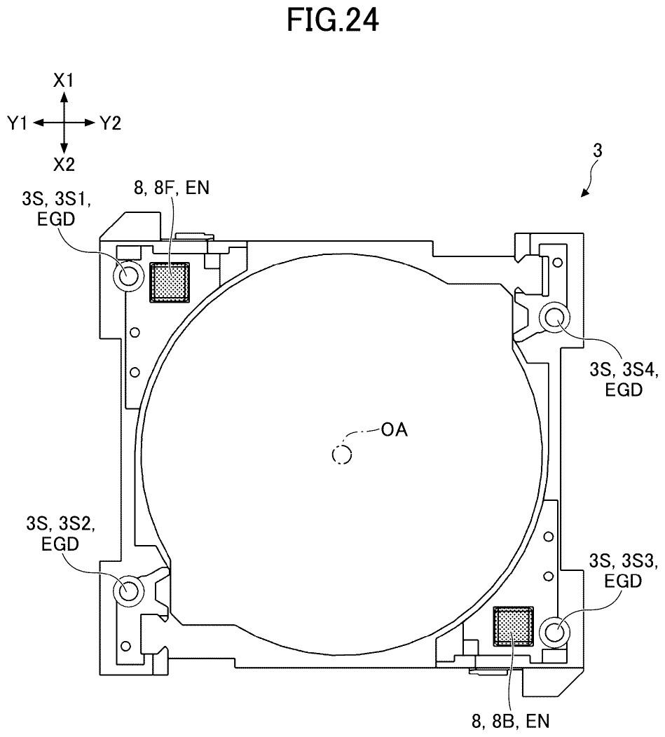

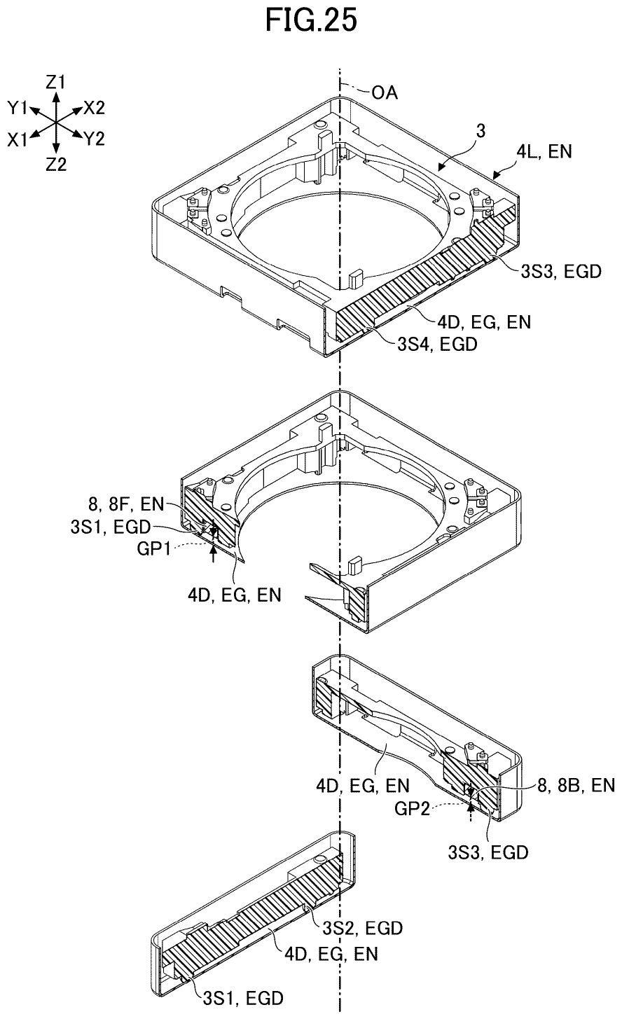

Next, with reference to FIGS. 24 and 25, a relationship between the outer guide EG, the outer guided part EGD, and the outer energizer EN will be described. FIG. 24 is a bottom view illustrating the support 3 to which the magnets 8 constituting the outer energizer EN are attached. In FIG. 24, for clarity, a dotted pattern is applied to the magnets 8 housed in the recesses 30 of the support 3 (see the upper figure of FIG. 12) and fixed thereto with an adhesive or the like.

As illustrated in FIG. 24, the projecting portion 3S projecting downward of the support 3 is formed on the lower surface of the support 3. In the illustrated example, the projecting portion 3S forms the outer guided part EGD, which is a part guided by the bottom plate 4D of the lower cover 4L that functions as the outer guide EG, and includes a first projecting portion 3S1 to a fourth projecting portion 3S4.

Specifically, each of the first projecting portion 3S1 to the fourth projecting portion 354 has the same amount of projection, and is configured to simultaneously contact the bottom plate 4D of the lower cover 4L and slide over the bottom plate 4D. The first projecting portion 3S1 to the fourth projecting portion 3S4 are individually arranged to correspond to one of the four corners of the support 3. The first projecting portion 3S1 to the fourth projecting portion 3S4 are arranged so that their distances from the optical axis OA are equal to each other. However, the number of projections 3S may be three or five or more. When the bottom plate 4D can be simultaneously contacted, the projections of the first projecting portion 3S1 to the fourth projecting portion 354 may be different from each other. The first projecting portion 3S1 to the fourth projecting portion 3S4 may be arranged so that their distances from the optical axis OA are different from each other.

As illustrated in FIG. 25, the support 3 is configured so that the magnet 8 is arranged at a predetermined distance from the bottom plate 4D while the bottom plate 4D of the lower cover 4L is in contact with the projections 3S.

FIG. 25 is a perspective cross-sectional view illustrating the lower cover 4L housing the support 3. Specifically, the top figure of FIG. 25 is a view including cross sections of a third projecting portion 353 and the fourth projecting portion 3S4. The second figure from the top of FIG. 25 is a view including cross sections of the first projecting portion 3S1 and the front magnet 8F. The third figure from the top of FIG. 25 is a view including cross sections of the third projecting portion 3S3 and the rear magnet 8B. The bottom figure of FIG. 25 is a view including cross sections of the first projecting portion 31 and a second projecting portion 3S2.

More specifically, the support 3 is configured such that the bottom plate 4D and the front magnet 8F are arranged at a distance GP1 apart, as illustrated in the second figure from the top of FIG. 25, and the bottom plate 4D and the rear magnet 8B are arranged at a distance GP2 apart, as illustrated in the third figure from the top of FIG. 25.

In the illustrated example, the support 3 is configured so that the distance GP1 and the distance GP2 are the same, but the distance GP1 and the distance GP2 may be configured so as to be different from each other. The number of magnets 8 may be one or three or more.

With this configuration, the magnets 8 and the bottom plate 4D of the lower cover 4L, which are included in the outer energizer EN, can move the support 3 in a direction perpendicular to the optical axis direction relative to the lower cover 4L, while the support 3 and the lower cover 4L are in contact with each other. This is because the support 3 is attracted to the bottom plate 4D of the lower cover 4L by the magnetic force of the magnets 8 attached to the support 3.

As described above, the lens drive device 101 according to the embodiment of the present disclosure includes, as illustrated in FIG. 3, a support 3, a lens holder 2 that includes a cylinder 12 in which the lens body LS can be arranged and is movable in the optical axis direction relative to the support 3, and a plurality of shape memory alloy wires SA (the lower shape memory alloy wire SAD) provided between the support 3 and the lens holder 2 and configured to move the lens holder 2 in the optical axis direction. The support 3 includes an inner guide IG (guide member 7) for guiding the movement of the lens holder 2 in the optical axis direction, and a first magnetic member 9. The lens holder 2 includes an inner guided part IGD (groove 2V) which slides with the inner guide IG (guide member 7) and is guided to the inner guide IG (guide member 7), and a second magnetic member 10 arranged at a position apart from the first magnetic member 9 in a direction crossing the optical axis direction. At least one of the first magnetic member 9 or the second magnetic member 10 is formed of a magnet, and is arranged so that the inner guide IG (guide member 7) and the inner guided part IGD (groove 2V) push each other in a direction crossing the optical axis direction by a magnetic force generated between the first magnetic member 9 and the second magnetic member 10, so that the inner guide IG (guide member 7) and the inner guided part IGD (groove 2V) come into contact with each other regardless of the position of the lens holder 2 in the optical axis direction.

With this configuration, the lens drive device 101 can realize power saving. Since a contact force (friction force) acts between the support 3 (inner guide IG (guide member 7)) and the lens holder 2 (inner guided part IGD (groove 2V)), the lens drive device 101 can hold the position of the lens holder 2 without flowing a current to the shape memory alloy wire SA (lower shape memory alloy wire SAD) or by flowing a small current.

In addition, the shape memory alloy wire SA (lower shape memory alloy wire SAD) may be contracted so as to reduce the force (friction force) of the inner guide IG (guide member 7) and the inner guided part IGD (groove 2V) to push each other when a current flows to the shape memory alloy wire SA (lower shape memory alloy wire SAD) as compared to when no current flows to the shape memory alloy wire SA (lower shape memory alloy wire SAD), as illustrated in the upper figure of FIG. 23.

With this configuration, the lens drive device 101 can reduce the contact force (friction force) between the inner guide IG (guide member 7) and the inner guided part IGD (groove 2V) when the lens holder 2 is moved in the optical axis direction. Accordingly, the position of the lens holder 2 can be easily maintained by increasing the contact force (friction force) when the lens is not energized.

The shape memory alloy wire SA (lower shape memory alloy wire SAD) may include, as illustrated in the upper figure of FIG. 23, a first wire (first lower wire SAD1) in which one end supported by the support 3 is disposed at a lower position in the optical axis direction than the other end supported by the lens holder 2, and a second wire (second lower wire SAD2) in which one end supported by the support 3 is disposed at a higher position in the optical axis direction than the other end supported by the lens holder 2. In this case, the first wire (first lower wire SAD1) and the second wire (second lower wire SAD2) may have one end fixed to the first metal member (support-side metal member 5S) provided on the support 3, and the other end fixed to the second metal member (lens-side metal member 5L) provided on the lens holder 2. Further, the first wire (first lower wire SAD1) and the second wire (second lower wire SAD2) may each be arranged such that the position where one end thereof is fixed to the first metal member (support-side metal member 5S) is farther from the inner guide IG (guide member 7) than is the position where the other end is fixed to the second metal member (lens-side metal member 5L), in the direction crossing the optical axis direction (Y-axis direction).

With this arrangement, the lens drive device 101 can easily move the lens holder 2 up and down by the first lower wire SAD1 and the second lower wire SAD2. In addition, the lens drive device 101 can effectively reduce the contact force (friction force) between the inner guide IG (guide member 7) and the inner guided part IGD (groove 2V) when energized.

The second magnetic member 10 and the inner guided part IGD (groove 2V) may be arranged at adjacent positions in the lens holder 2 as illustrated in the upper figure of FIG. 22. Here, “adjacent” preferably means that a distance DS1 between the second magnetic member 10 (second front magnetic member 10F) and the inner guided part IGD (groove 2V (front groove 2VF)) in the Y-axis direction is smaller than half of the length of the lower shape memory alloy wire SAD, and more preferably, means that the distance DS1 is smaller than a length DS2 (see FIG. 7) of the inner guided part IGD (groove 2V) in the optical axis direction. In this way, rotation of the lens holder 2 around the inner guide IG (guide member 7) can be restricted.

With this configuration, the lens drive device 101 can increase the force of pushing the inner guide IG (guide member 7) and the inner guided part IGD (groove 2V) against each other.

The first magnetic member 9 and the second magnetic member 10 may both be formed of magnets. In this case, the magnetic force generated between the first magnetic member 9 and the second magnetic member 10 may be an attractive force.

This configuration brings about an effect of increase in the force of the lens holder 2 and the support 3 attracting each other, when compared with the configuration in which either of the first magnetic member 9 or the second magnetic member 10 is not a magnet.

In addition, the first magnetic member 9 may be attached to the support 3 through the slip-off preventer as illustrated in FIG. 12, and the second magnetic member 10 may be attached to the lens holder 2 through the slip-off preventer as illustrated in FIG. 8.

This configuration brings about an effect of suppression of falling out of the first magnetic member 9 and the second magnetic member 10 in the direction in which the magnetic force generated between the first magnetic member 9 and the second magnetic member 10 acts.

The inner guide IG (guide member 7) may have a curved surface projecting toward the inner guided part IGD (groove 2V) as illustrated in the upper figure of FIG. 22. In this case, the inner guided part IGD (groove 2V) may have a recess that can receive the projection as illustrated in the upper figure of FIG. 22. In the illustrated example, the guide member 7 includes a nearly cylindrical projection that projects toward the groove 2V, and the groove 2V includes a recess that can receive the nearly cylindrical projection.

This configuration brings about an effect of that the lens drive device 101 is easier to downsize than the configuration in which the inner guide IG (guide member 7) is provided on the lens holder 2 and the inner guided part IGD is provided on the support 3. This is because the inner guide IG (guide member 7) is preferably configured so that its length in the optical axis direction is greater than the length of the inner guided part IGD.

The support 3 may also include two inner guides IG (rear guide member 7B and front guide member 7F), as illustrated in the central figure of FIG. 12. In this case, as illustrated in the upper figure of FIG. 22, the lens holder 2 may include two inner guided parts IGD (rear groove 2VB and front groove 2VF). In this case, the two inner guided parts IGD (rear groove 2VB and front groove 2VF) may be configured such that one of the inner guided parts IGD is a V-shaped groove (a groove receiving the guide member 7 in two places) and the other of the inner guided parts IGD is a U-shaped groove (a groove receiving the guide member 7 in one place). In the illustrated example, the rear groove 2VB is a V-shaped groove and the front groove 2VF is a U-shaped groove.

Compared with the configuration in which the support 3 includes one inner guide IG and the lens holder 2 includes one inner guided part IGD, this configuration brings about the effect of stabilizing the posture of the lens holder 2 when moving the lens holder 2 in the optical axis direction.

The two inner guides IG (the rear guide member 7B and the front guide member 7F) may be arranged so as to face each other across the optical axis OA as illustrated in the upper figure of FIG. 22. In this case, the two inner guided parts IGD (the rear groove 2VB and the front groove 2VF) may be arranged so as to face each other across the optical axis OA.

Compared with the arrangement in which the two inner guides IG are arranged closer together, this arrangement brings about the effect of stabilizing the posture of the lens holder 2 when moving the lens holder 2 in the optical axis direction.

Further, the first wire (the first lower wire SAD1) and the second wire (the second lower wire SAD2) may be arranged so as to face each other in a side view viewed from a direction perpendicular to the optical axis direction, as illustrated in the lower figure of FIG. 22, to form a wire pair. In this case, the shape memory alloy wire SA may include two wire pairs as illustrated in the upper figure of FIG. 22. One wire pair (the first lower wire SAD1 and the second lower wire SAD2) and the other wire pair (the third lower wire SAD3 and the fourth lower wire SAD4) may be arranged so as to face each other across the optical axis OA.

This configuration brings about the effect that the posture of the lens holder 2 when moving the lens holder 2 in the optical axis direction can be stabilized compared to the configuration in which the first driver DM1 is realized by one wire pair. Furthermore, this configuration also brings about the effect that the drive force of the first driver DM1 can be increased compared to the configuration in which the first driver DM1 is realized by one wire pair.

Further, as illustrated in FIG. 25, the lens drive device 101 may be provided with a fixed-side member FB (lower cover 4L) including a flat outer guide EG (bottom plate 4D) for guiding the support 3 in the direction perpendicular to the optical axis direction (X-axis direction and Y-axis direction), and the driver DM (second driver DM2) for moving the support 3 in the direction perpendicular to the optical axis direction (X-axis direction and Y-axis direction).

This configuration brings about the effect that the posture of the support 3 when moving the support 3 in the direction perpendicular to the optical axis direction can be stabilized compared with the configuration without the flat outer guide EG.

According to the present disclosure described above, a lens drive device that can save power is provided.

The preferred embodiment of the present invention has been described in detail. However, the present invention is not limited to the embodiment described above. The embodiment described above may be subject to various modifications, substitutions, etc., without departing from the scope of the present invention. In addition, each of the features described with reference to the embodiment described above may be combined as appropriate, provided that they are not technically inconsistent.

For example, in the embodiment described above, contact between the inner guide IG and the inner guided part IGD is achieved by contact between a metal and a synthetic resin, but may be achieved by contact between metals or synthetic resins.

What is claimed is:

1. A lens drive device, comprising:
a support;
a lens holder that includes a cylinder configured to arrange a lens body in the cylinder, and that is movable with respect to the support in a direction of an optical axis; and
a plurality of shape memory alloy wires that are provided between the support and the lens holder, and that are configured to move the lens holder in the direction of the optical axis, wherein
the support includes a guide and a first magnetic member, the guide being configured to guide the lens holder to move in the direction of the optical axis,
the lens holder includes a guided part and a second magnetic member, the guided part being configured to slide with the guide and be guided by the guide, and the second magnetic member being arranged at a position apart from the first magnetic member in a direction crossing the direction of the optical axis, and
at least one of the first magnetic member or the second magnetic member is formed of a magnet,
a magnetic force is generated between the first magnetic member and the second magnetic member,
the magnetic force exerts a force to push the guide and the guided part against each other in the direction crossing the direction of the optical axis, and
the guide and the guided part are arranged to be in a contacted state regardless of a position of the lens holder in the direction of the optical axis.

2. The lens drive device according to claim 1, wherein
the shape memory alloy wires are configured to contract so as to reduce the force to push the guide and the guided part against each other in a case in which a current flows through the shape memory alloy wires, compared to a case in which no current is flowing through the shape memory alloy wires.

3. The lens drive device, according to claim 2, wherein
the shape memory alloy wires include
a first wire including one end supported by the support and another end supported by the lens holder, the one end being disposed at a lower position in the direction of the optical axis than the another end, and
a second wire including one end supported by the support and another end supported by the lens holder, the one end being disposed at a higher position in the direction of the optical axis than the another end, and
in each of the first wire and the second wire,
the one end is fixed to a first metal member provided in the support, and the another end is fixed to a second metal member provided in the lens holder, and
in the direction crossing the direction of the optical axis, a position at which the one end is fixed to the first metal member is farther from the guide than is a position at which the another end is fixed to the second metal member.

4. The lens drive device according to claim 1, wherein
the second magnetic member and the guided part are arranged at positions next to each other in the lens holder.

5. The lens drive device according to claim 2, wherein
the second magnetic member and the guided part are arranged at positions next to each other in the lens holder.

6. The lens drive device according to claim 3, wherein
the second magnetic member and the guided part are arranged at positions next to each other in the lens holder.

7. The lens drive device according to claim 4, wherein
both of the first magnetic member and the second magnetic member are formed of a magnet, and
the magnetic force is an attractive force.

8. The lens drive device according to claim 7, wherein
the first magnetic member is attached to the support through a slip-off preventer, and
the second magnetic member is attached to the lens holder by a slip-off preventer.

9. The lens drive device according to claim 1, wherein
the guide includes a projection that has a curved surface projecting toward the guided part, and
the guided part includes a recess configured to receive the projection.

10. The lens drive device according to claim 2, wherein
the guide includes a projection that has a curved surface projecting toward the guided part, and
the guided part includes a recess configured to receive the projection.

11. The lens drive device according to claim 3, wherein
the guide includes a projection that has a curved surface projecting toward the guided part, and
the guided part includes a recess configured to receive the projection.

12. The lens drive device according to claim 1, wherein
the support includes two guides each being the guide, and
the lens holder includes two guided parts each being the guided part.

13. The lens drive device according to claim 2, wherein
the support includes two guides each being the guide, and
the lens holder includes two guided parts each being the guided part.

14. The lens drive device according to claim 3, wherein
the support includes two guides each being the guide, and
the lens holder includes two guided parts each being the guided part.

15. The lens drive device according to claim 12, wherein
the two guides are arranged so as to face each other across the optical axis, and
the two guided parts are arranged so as to face each other across the optical axis.

16. The lens drive device according to claim 3, wherein
a single first wire being the first wire and a single second wire being the second wire are arranged so as to cross each other in a side view viewed from a direction perpendicular to the direction of the optical axis, to form a wire pair, and
the shape memory alloy wire includes two wire pairs each being the wire pair, and one of the wire pairs and another of the wire pairs are arranged so as to face each other across the optical axis.

17. The lens drive device according to claim 1, comprising:
a fixed-side member that includes an outer guide configured to guide the support in a direction perpendicular to the optical axis; and
a driver configured to drive the support in a direction perpendicular to the direction of the optical axis.

18. A camera module, comprising:
the lens drive device according to claim 1;
the lens body held by the lens holder; and
an imaging element arranged so as to face the lens body.
